(19) United States
(12) Patent Application Publication
(10) Pub. No.: US 2024/0381349 A1
(43) Pub. Date: Nov. 14, 2024

(54) USER EQUIPMENT, BASE STATION, AND METHOD FOR SIMULTANEOUS TRANSMISSION WITH MULTI-PANEL (STxMP) OPERATIONS

(71) Applicant: FG Innovation Company Limited, Tuen Mun (HK)

(72) Inventors: YEN-HUA LI, Taipei (TW); MEI-JU SHIH, Taipei (TW); WAN-CHEN LIN, Taipei (TW); CHIA-HUNG LIN, Taipei (TW); PO-CHUN CHOLI, Taipei (TW)

(21) Appl. No.: 18/662,115

(22) Filed: May 13, 2024

Related U.S. Application Data
(60) Provisional application No. 63/466,020, filed on May 12, 2023.

(51) Int. Cl. H04W 72/1268; H04L 5/00; H04W 72/231

(52) U.S. Cl. CPC H04W 72/1268; H04L 5/0051; H04W 72/231

(57) ABSTRACT

A method performed by a User Equipment (UE) for a Simultaneous Transmission with Multi-Panel (STxMP) operation is provided. The method receives a configuration for multi-DCI based STxMP Physical Uplink Shared Channel (PUSCH). The method receives a Sounding Reference Signal (SRS) resource set configuration including a first SRS resource set and a second SRS resource set. The method receives first DCI in a first Control Resource Set (CORESET) and second DCI in a second CORESET. The method determines a size of a first field in the first DCI and a size of a second field in the second DCI based on the number of first SRS resources in the first SRS resource set and the number of second SRS resources in the second SRS resource set, respectively. The method transmits a first PUSCH and a second PUSCH scheduled by the first DCI and the second DCI, respectively.

### CROSS-REFERENCE TO RELATED APPLICATION(S)

The present application claims the benefit of and priority to U.S. Provisional Patent Application Ser. No. 63/466,020, filed on May 12, 2023, entitled “METHOD AND APPARATUS FOR SIMULTANEOUS TRANSMISSION ON MULTIPLE PANELS,” the content of which is hereby incorporated herein fully by reference into the present disclosure for all purposes.

### FIELD

The present disclosure is related to wireless communication and, more specifically, to User Equipment (UE), Base Station (BS), and method for Simultaneous Transmission with Multi-Panel (STxMP) operations in cellular wireless communication networks.

### BACKGROUND

Various efforts have been made to improve different aspects of wireless communication for the cellular wireless communication systems, such as the 5^{th} Generation (5G) New Radio (NR), by improving data rate, latency, reliability, and mobility. The 5G NR system is designed to provide flexibility and configurability to optimize network services and types, accommodating various use cases, such as enhanced Mobile Broadband (eMBB), massive Machine-Type Communication (mMTC), and Ultra-Reliable and Low-Latency Communication (URLLC). As the demand for radio access continues to increase, however, there exists a need for further improvements in the next-generation wireless communication systems.

### SUMMARY

The present disclosure is related to a UE, a BS, and a method for an STxMP operation in cellular wireless communication networks.

In a first aspect of the present application, a method performed by a UE for an STxMP operation is provided. The method includes receiving, from a BS, a configuration for multi-DCI based STxMP Physical Uplink Shared Channel (PUSCH); receiving, from the BS, a Sounding Reference Signal (SRS) resource set configuration including a first SRS resource set and a second SRS resource set; receiving, from the BS, first DCI in a first Control Resource Set (CORESET) associated with a first CORESET pool index; receiving, from the BS, second DCI in a second CORESET associated with a second CORESET pool index different from the first CORESET pool index; determining a size of a first field in the first DCI based on a number of first SRS resources configured in the first SRS resource set; determining a size of a second field in the second DCI based on a number of second SRS resources configured in the second SRS resource set; transmitting, to the BS, a first PUSCH scheduled by the first DCI based on the first field; and transmitting, to the BS, a second PUSCH scheduled by the second DCI based on the second field.

In some implementations of the first aspect, the first DCI includes a DCI format 0_1, and the second DCI includes the DCI format 0_1.

In some implementations of the first aspect, the first field in the first DCI includes a first SRS resource indicator (SRI) field, and the second field in the second DCI includes a second SRI field.

In some implementations of the first aspect, both the first SRS resource set and the second SRS resource set are used for non-codebook-based PUSCH transmission. The first field indicates a first precoder applied to the first PUSCH, and the second field indicates a second precoder applied to the second PUSCH.

In some implementations of the first aspect, both the first SRS resource set and the second SRS resource set are used for codebook-based PUSCH transmission. In a case that the size of the first field is not zero, the first field indicates a first beam applied to the first PUSCH. In a case that the size of the second field is not zero, the second field indicates a second beam applied to the second PUSCH.

In some implementations of the first aspect, the number of the second SRS resources configured in the second SRS resource set is one, and the size of the second field in the second DCI is zero.

In some implementations of the first aspect, the method further includes determining a size of the first DCI and a size of the second DCI. The size of the first DCI is the same as the size of the second DCI. The size of the first field in the first DCI is different from the size of the second field in the second DCI.

In some implementations of the first aspect, the first PUSCH and the second PUSCH overlap in time domain and frequency domain.

In a second aspect of the present application, a UE for an STxMP operation is provided. The UE includes at least one processor and at least one non-transitory computer-readable medium storing one or more computer-executable instructions. The computer-executable instructions, when executed by the at least one processor, cause the UE to: receive, from a BS, a configuration for multi-DCI based STxMP PUSCH; receive, from the BS, an SRS resource set configuration including a first SRS resource set and a second SRS resource set; receive, from the BS, first DCI in a first CORESET associated with a first CORESET pool index; receive, from the BS, second DCI in a second CORESET associated with a second CORESET pool index different from the first CORESET pool index; determine a size of a first field in the first DCI based on a number of first SRS resources configured in the first SRS resource set; determine a size of a second field in the second DCI based on a number of second SRS resources configured in the second SRS resource set; transmit, to the BS, a first PUSCH scheduled by the first DCI based on the first field; and transmit, to the BS, a second PUSCH scheduled by the second DCI based on the second field.

In a third aspect of the present application, a BS for configuring an STxMP operation is provided. The BS includes at least one processor and at least one non-transitory computer-readable medium storing one or more computer-executable instructions. The computer-executable instructions, when executed by the at least one processor, cause the BS to: transmit, to a UE, a configuration for multi-DCI based STxMP PUSCH; transmit, to the UE, an SRS resource set configuration including a first SRS resource set and a second SRS resource set; transmit, to the UE, first DCI in a first CORESET associated with a first CORESET pool index; transmit, to the UE, second DCI in a second CORESET associated with a second CORESET pool index different from the first CORESET pool index; receive, from the UE, a first PUSCH scheduled by the first DCI; and receive, from the UE, a second PUSCH scheduled by the second DCI. The SRS resource set configuration enables the UE to determine a size of a first field in the first DCI based on a number of first SRS resources configured in the first SRS resource set. The first DCI enables the UE to transmit the first PUSCH based on the first field. The SRS resource set configuration enables the UE to determine a size of a second field in the second DCI based on a number of second SRS resources configured in the second SRS resource set. The second DCI enables the UE to transmit the second PUSCH based on the second field.

### BRIEF DESCRIPTION OF THE DRAWINGS

Aspects of the present disclosure are best understood from the following detailed disclosure when read with the accompanying drawings. Various features are not drawn to scale. Dimensions of various features may be arbitrarily increased or reduced for clarity of discussion.

FIG. 1 is a flowchart illustrating a method/process performed by a UE for an STxMP operation, according to an example implementation of the present disclosure.

FIG. 2 is a flowchart illustrating a method/process performed by a BS for an STxMP operation, according to an example implementation of the present disclosure.

FIG. 3 is a block diagram illustrating a node for wireless communication, according to an example implementation of the present disclosure.

### DESCRIPTION

Some abbreviations used in the present disclosure include:

| Abbreviation | Full name |
|---|---|
| 3GPP | 3^{rd} Generation Partnership Project |
| 5G | 5^{th} Generation |
| 5GC | 5G Core Network |
| A-CSI | Aperiodic CSI |
| ACK | Acknowledgment |
| AS | Access Stratum |
| BS | Base Station |
| BWP | Bandwidth Part |
| C-RNTI | Cell Radio Network Temporary Identifier |
| CA | Carrier Aggregation |
| CC | Component Carrier |
| CG | Configured Grant |
| CN | Core Network |
| CORESET | Control Resource Set |
| CPE | Customer Premise Equipment |
| CRC | Cyclic Redundancy Check |
| CS-RNTI | Configured Scheduling RNTI |
| CSI | Channel State Information |
| CSI-RS | Channel State Information Reference Signal |
| DC | Dual Connectivity |
| DCI | Downlink Control Information |
| DL | Downlink |
| DRB | Data Radio Bearer |
| EPC | Evolved Packet Core |
| E-UTRAN | Evolved Universal Terrestrial Radio Access Network |
| FDD | Frequency Division Duplex |
| FDM | Frequency Division Multiplexing |
| FR | Frequency Range |
| FWA | Fixed Wireless Access |
| HARQ-ACK | Hybrid Automatic Repeat Request - Acknowledgment |
| ID | Identifier |
| IE | Information Element |
| L1 | Layer 1 |
| LRR | Link Recovery Request |
| LSB | Least Significant Bit |
| LTE | Long Term Evolution |
| M-DCI | Multi-DCI |
| MAC | Medium Access Control |
| MAC CE | MAC Control Element |
| MCG | Master Cell Group |
| MCS-C-RNTI | Modulation and Coding Scheme C-RNTI |
| MIB | Master Information Block |
| MIMO | Multiple Input Multiple Output |
| MN | Master Node |
| MR-DC | Multi-Radio Dual Connectivity |
| MSB | Most Significant Bit |
| mTRP | Multi-TRP |
| NAS | Non Access Stratum |
| NDI | New Data Indicator |
| NE-DC | NR - E-UTRA Dual Connectivity |
| NG-RAN | Next Generation Radio Access Network |
| NR | New Radio |
| NW | Network |
| NZP | Non-Zero Power |
| OFDM | Orthogonal Frequency Division Multiplexing |
| PBCH | Physical Broadcast Channel |
| PCell | Primary Cell |
| PCI | Physical Cell ID |
| PDCCH | Physical Downlink Control Channel |
| PDSCH | Physical Downlink Shared Channel |
| PHY | Physical (layer) |
| PMI | Precoding Matrix Indicator |
| PRACH | Physical Random Access Channel |
| PSCell | Primary SCG Cell |
| PUCCH | Physical Uplink Control Channel |
| PUSCH | Physical Uplink Shared Channel |
| RA | Random Access |
| RAN | Radio Access Network |
| RAR | Random Access Response |
| RAT | Radio Access Technology |
| Rel | Release |
| RE | Resource Element |
| RF | Radio Frequency |
| RI | Rank Indicator |
| RNTI | Radio Network Temporary Identifier |
| RRC | Radio Resource Control |
| RS | Reference Signal |
| RSRP | Reference Signal Received Power |
| S-DCI | Single-DCI |
| SCell | Secondary Cell |
| SCG | Secondary Cell Group |
| SDM | Space Division Multiplexing |
| SFN | Single-Frequency Network |
| SI | System Information |
| SIB | System Information Block |
| SL | Sidelink |
| SN | Secondary Node |
| SR | Scheduling Request |
| SRI | SRS Resource Indicator |
| SRS | Sounding Reference Signal |
| SS | Synchronization Signal |
| SSB | Synchronization Signal Block |
| STRP | Single-TRP |
| STxMP | Simultaneous Transmission with Multi-Panel |
| TA | Tracking Area |
| TB | Transport Block |
| TCI | Transmission Configuration Indicator |
| TDD | Time Division Duplex |
| TDM | Time Division Multiplexing |
| TDRA | Time Domain Resource Assignment |
| TPMI | Transmission Precoding Matrix Indicator |
| TRP | Transmission Reception Point |
| TS | Technical Specification |
| TTI | Transmission Time Interval |
| UCI | Uplink Control Information |
| UE | User Equipment |
| UL | Uplink |
| UL-SCH | Uplink Shared Channel |
| URLLC | Ultra-Reliable and Low-Latency Communication |

The following contains specific information related to implementations of the present disclosure. The drawings and their accompanying detailed disclosure are merely directed to implementations. However, the present disclosure is not limited to these implementations. Other variations and implementations of the present disclosure will be obvious to those skilled in the art.

Unless noted otherwise, like or corresponding elements among the drawings may be indicated by like or corresponding reference numerals. Moreover, the drawings and illustrations in the present disclosure are generally not to scale and are not intended to correspond to actual relative dimensions.

For the purposes of consistency and ease of understanding, like features may be identified (although, in some examples, not illustrated) by the same numerals in the drawings. However, the features in different implementations may be different in other respects and may not be narrowly confined to what is illustrated in the drawings.

References to “one implementation,” “an implementation,” “example implementation,” “various implementations,” “some implementations,” “implementations of the present application,” etc., may indicate that the implementation(s) of the present application so described may include a particular feature, structure, or characteristic, but not every possible implementation of the present application necessarily includes the particular feature, structure, or characteristic. Further, repeated use of the phrase “In some implementations,” or “in an example implementation,” “an implementation,” do not necessarily refer to the same implementation, although they may. Moreover, any use of phrases like “implementations” in connection with “the present application” are never meant to characterize that all implementations of the present application must include the particular feature, structure, or characteristic, and should instead be understood to mean “at least some implementations of the present application” includes the stated particular feature, structure, or characteristic. The term “coupled” is defined as connected, whether directly or indirectly through intervening components, and is not necessarily limited to physical connections. The term “comprising,” when utilized, means “including, but not necessarily limited to”; it specifically indicates open-ended inclusion or membership in the so-described combination, group, series, and the equivalent.

The expression “at least one of A, B and C” or “at least one of the following: A, B and C” means “only A, or only B, or only C, or any combination of A, B and C.” The terms “system” and “network” may be used interchangeably. The term “and/or” is only an association relationship for describing associated objects and represents that three relationships may exist such that A and/or B may indicate that A exists alone, A and B exist at the same time, or B exists alone. The character “/” generally represents that the associated objects are in an “or” relationship.

For the purposes of explanation and non-limitation, specific details, such as functional entities, techniques, protocols, and standards, are set forth for providing an understanding of the disclosed technology. In other examples, detailed disclosure of well-known methods, technologies, systems, and architectures are omitted so as not to obscure the present disclosure with unnecessary details.

Persons skilled in the art will immediately recognize that any network function(s) or algorithm(s) disclosed may be implemented by hardware, software, or a combination of software and hardware. Disclosed functions may correspond to modules which may be software, hardware, firmware, or any combination thereof.

A software implementation may include computer executable instructions stored on a computer-readable medium, such as memory or other type of storage devices. One or more microprocessors or general-purpose computers with communication processing capability may be programmed with corresponding executable instructions and perform the disclosed network function(s) or algorithm(s).

The microprocessors or general-purpose computers may include Application-Specific Integrated Circuits (ASICs), programmable logic arrays, and/or one or more Digital Signal Processor (DSPs). Although some of the disclosed implementations are oriented to software installed and executing on computer hardware, alternative implementations implemented as firmware, as hardware, or as a combination of hardware and software are well within the scope of the present disclosure. The computer-readable medium includes but is not limited to Random Access Memory (RAM), Read Only Memory (ROM), Erasable Programmable Read-Only Memory (EPROM), Electrically Erasable Programmable Read-Only Memory (EEPROM), flash memory, Compact Disc Read-Only Memory (CD-ROM), magnetic cassettes, magnetic tape, magnetic disk storage, or any other equivalent medium capable of storing computer-readable instructions.

A radio communication network architecture such as a Long-Term Evolution (LTE) system, an LTE-Advanced (LTE-A) system, an LTE-Advanced Pro system, or a 5G NR Radio Access Network (RAN) typically includes at least one base station (BS), at least one UE, and one or more optional network elements that provide connection within a network. The UE communicates with the network such as a Core Network (CN), an Evolved Packet Core (EPC) network, an Evolved Universal Terrestrial RAN (E-UTRAN), a 5G Core (5GC), or an internet via a RAN established by one or more BSs.

A UE may include, but is not limited to, a mobile station, a mobile terminal or device, or a user communication radio terminal. The UE may be a portable radio equipment that includes, but is not limited to, a mobile phone, a tablet, a wearable device, a sensor, a vehicle, or a Personal Digital Assistant (PDA) with wireless communication capability. The UE is configured to receive and transmit signals over an air interface to one or more cells in a RAN.

The BS may be configured to provide communication services according to at least a Radio Access Technology (RAT) such as Worldwide Interoperability for Microwave Access (WiMAX), Global System for Mobile communications (GSM) that is often referred to as 2G, GSM Enhanced Data rates for GSM Evolution (EDGE) RAN (GERAN), General Packet Radio Service (GPRS), Universal Mobile Telecommunication System (UMTS) that is often referred to as 3G based on basic wideband-code division multiple access (W-CDMA), high-speed packet access (HSPA), LTE, LTE-A, evolved LTE (eLTE) that is LTE connected to 5GC, NR (often referred to as 5G), and/or LTE-A Pro. However, the scope of the present disclosure is not limited to these protocols.

The BS may include, but is not limited to, a node B (NB) in the UMTS, an evolved node B (eNB) in LTE or LTE-A, a radio network controller (RNC) in UMTS, a BS controller (BSC) in the GSM/GERAN, an ng-eNB in an Evolved Universal Terrestrial Radio Access (E-UTRA) BS in connection with 5GC, a next generation Node B (gNB) in the 5G-RAN, or any other apparatus capable of controlling radio communication and managing radio resources within a cell. The BS may serve one or more UEs via a radio interface.

The BS may be operable to provide radio coverage to a specific geographical area using multiple cells forming the RAN. The BS supports the operations of the cells. Each cell is operable to provide services to at least one UE within its radio coverage.

Each cell (may often referred to as a serving cell) may provide services to one or more UEs within the cell's radio coverage, such that each cell schedules the DL and optionally UL resources to at least one UE within its radio coverage for DL and optionally UL packet transmissions. The BS may communicate with one or more UEs in the radio communication system via the of cells.

A cell may allocate sidelink (SL) resources for supporting Proximity Services (ProSe) or Vehicle to Everything (V2X) services. Each cell may have overlapped coverage areas with other cells.

In Multi-RAT Dual Connectivity (MR-DC) cases, the primary cell of a Master Cell Group (MCG) or a Secondary Cell Group (SCG) may be called a Special Cell (SpCell). A Primary Cell (PCell) may include the SpCell of an MCG. A Primary SCG Cell (PSCell) may include the SpCell of an SCG. MCG may include a group of serving cells associated with the Master Node (MN), including the SpCell and optionally one or more Secondary Cells (SCells). An SCG may include a group of serving cells associated with the Secondary Node (SN), including the SpCell and optionally one or more SCells.

As discussed above, the frame structure for NR supports flexible configurations for accommodating various next generation (e.g., 5G) communication requirements, such as Enhanced Mobile Broadband (eMBB), Massive Machine Type Communication (mMTC), and Ultra-Reliable and Low-Latency Communication (URLLC), while fulfilling high reliability, high data rate, and low latency requirements. The Orthogonal Frequency-Division Multiplexing (OFDM) technology in the 3GPP may serve as a baseline for an NR waveform. The scalable OFDM numerology, such as adaptive sub-carrier spacing, channel bandwidth, and Cyclic Prefix (CP), may also be used.

Two coding schemes are considered for NR, specifically, Low-Density Parity-Check (LDPC) code and Polar Code. The coding scheme adaption may be configured based on channel conditions and/or service applications.

At least DL transmission data, a guard period, and a UL transmission data should be included in a transmission time interval (TTI) of a single NR frame. The respective portions of the DL transmission data, the guard period, and the UL transmission data should also be configurable based on, for example, the network dynamics of NR. SL resources may also be provided in an NR frame to support ProSe services or V2X services.

Any two or more than two of the following paragraphs, (sub)-bullets, points, actions, behaviors, terms, or claims described in the present disclosure may be combined logically, reasonably, and properly to form a specific method.

Any sentence, paragraph, (sub)-bullet, point, action, behaviors, terms, or claims described in the present disclosure may be implemented independently and separately to form a specific method.

Dependency, e.g., “based on”, “more specifically”, “preferably”, “in one embodiment”, “in some implementations”, etc., in the present disclosure is just one possible example which would not restrict the specific method.

“A and/or B” in the present disclosure may include either A or B, both A and B, at least one of A and B.

MIMO is one of the key technologies in the NR systems and is successful in commercial deployments. In Rel-15/16/17 of the 3GPP specification, MIMO features were investigated and specified for both the FDD and TDD systems, of which, major parts were for the downlink MIMO operations. In Rel-18 of the 3GPP specification, it is important to identify and specify necessary enhancements for the uplink MIMO, while necessary enhancements on the downlink MIMO that facilitate the use of large antenna array, not only for FR1, but also for FR2, may still need to be determined to fulfil the request for an evolution of the NR deployments. With the introduction of features for UL panel selection in Rel-17, advanced UEs (e.g., CPE, FWA, vehicle and industrial devices, etc.) may benefit from the higher UL coverage and average throughput with simultaneous UL multi-panel transmission.

The NW may serve a UE with multiple TRPs (e.g., two TRPs). The UE may transmit its UL channels and/or signals to the multiple TRPs. There may be several schemes to exploit the TRPs. For example, the UE may simultaneously transmit two UL channels/signals to the two TRPs, respectively. For example, the UE may transmit one UL channel/signal to one TRP within a first time interval, and then transmit one UL channel/signal to another TRP within a second time interval. Therefore, it should be noted that the STxMP may include a technique that is associated with UL mTRP.

In some implementations, for a UE provided with a transmission configuration (e.g., txConfig) and the txConfig=‘codebook’, only one or two SRS resource sets may be configured in a parameter srs-ResourceSetToAddModList with a higher-layer parameter usage in the SRS-ResourceSet set to ‘codebook’, and only one or two SRS resource sets may be configured in a parameter srs-ResourceSetToAddModListDCI-0-2 with the higher-layer parameter usage in the SRS-ResourceSet set to ‘codebook’.

In some implementations, when only one SRS resource set is configured in the srs-ResourceSetToAddModList or the srs-ResourceSetToAddModListDCI-0-2 with the usage in the SRS-ResourceSet set to ‘codebook’, the UE may perform the “sTRP PUSCH operations,” as described in the present disclosure.

In some implementations, when two SRS resource sets are configured in the srs-ResourceSetToAddModList or the srs-ResourceSetToAddModListDCI-0-2 with the usage in the SRS-ResourceSet set to ‘codebook’, the UE may perform the “mTRP PUSCH operations,” as described in the present disclosure.

In some implementations, for a UE provided with the txConfig and the txConfig=‘nonCodebook’, only one or two SRS resource sets may be configured in the srs-ResourceSetToAddModList with the higher-layer parameter usage in the SRS-ResourceSet set to ‘nonCodebook’, and only one or two SRS resource sets may be configured in the srs-ResourceSetToAddModListDCI-0-2 with the higher-layer parameter usage in the SRS-ResourceSet set to ‘nonCodebook’.

In some implementations, when only one SRS resource set is configured in the srs-ResourceSetToAddModList or the srs-ResourceSetToAddModListDCI-0-2 with the usage in the SRS-ResourceSet set to ‘nonCodebook’, the UE may perform the “sTRP PUSCH operations,” as described in the present disclosure.

In some implementations, when two SRS resource sets are configured in the srs-ResourceSetToAddModList or the srs-ResourceSetToAddModListDCI-0-2 with the usage in the SRS-ResourceSet set to ‘nonCodebook’, the UE may perform the “sTRP PUSCH operations” and the “mTRP PUSCH operations,” as described in the present disclosure.

In some implementations, the UE/NW behaviors, configurations, and operations described in the present disclosure may be associated with (e.g., occur within) a BWP of a serving cell.

In the present disclosure, the UE may receive the related configurations/parameters/DCIs from the serving cell (e.g., by using the beam associated with the serving cell) and/or the TRP associated with the serving cell.

sTRP PUSCH Operations

In some implementations, if a UE is provided with the txConfig and the txConfig=‘codebook’, the UE may be configured with one or two SRS resource sets in the srs-ResourceSetToAddModList or the srs-ResourceSetToAddModListDCI-0-2 with the usage in the SRS-ResourceSet set to ‘codebook’.

If the UE is configured with only one SRS resource set in the srs-ResourceSetToAddModList or the srs-ResourceSetToAddModListDCI-0-2 with the usage in the SRS-ResourceSet set to ‘codebook’, at least one of the following implementations may occur:
In some implementations, the UE may determine that a first SRI field exists in the DCI (e.g., the DCI format 0_1, the DCI format 0_2, or other DCI formats) if there is more than one SRS resource configured in the first SRS resource set, and the UE may determine that the first SRI field does not exist if there is only one SRS resource configured in the first SRS resource set.
In some implementations, the UE may determine that a first TPMI field (e.g., the precoding information and number of layers field) exists in the DCI (e.g., the DCI format 0_1, the DCI format 0_2, or other DCI formats). The UE may determine the size of the first TPMI field and the table with which the first TPMI field is associated based on at least one of a full power mode configuration, a maximum rank configuration, a transform precoder configuration, and a codebook subset configuration. The full power mode configuration may be “full power mode”, “full power mode 1”, or “full power mode 2”. The maximum rank configuration may be provided by a higher-layer parameter, such as the maxRank or maxRankDCI-0-2. The transform precoder configuration may be ‘enabled’, which instructs the UE to apply the transform precoder to the PUSCH transmission, or ‘disabled’, which instructs the UE not to apply the transform precoder to the PUSCH transmission. The codebook subset configuration may be “fully and partially and non-coherent”, “partially and non-coherent”, or “non-coherent”.
In some implementations, if a UE receives a DCI format 0_1 or 0_2 scheduling a PUSCH from the serving cell, the UE may determine its PUSCH transmission precoder based on the first TPMI field and the first SRI field and perform the PUSCH transmission using the beam associated with an SRS resource. If more than one SRS resource is configured in the SRS resource set with the usage in the SRS-ResourceSet set to ‘codebook’, the SRS resource may be indicated by the first SRI field. If only one SRS resource is configured in the SRS resource set with the usage set to ‘codebook’, the SRS resource may be the SRS resource configured in the SRS resource set.
In some implementations, if a UE is provided with a Type-1 CG configuration, the UE may perform the PUSCH transmission periodically, where the period may be provided by a parameter in the CG configuration (e.g., the parameter periodicity, periodicityExt-r16, or periodicityExt-r17), perform precoding to each PUSCH based on the TPMI configured by a parameter provided in the CG configuration (e.g., precodingAndNumberOfLayers) with the number of layers configured by a parameter provided in the CG configuration (e.g., precodingAndNumberOfLayers), and perform the PUSCH transmissions using the beam associated with an SRS resource. If more than one SRS resource is configured in the SRS resource set with the usage set to ‘codebook’, the SRS resource may be indicated by a parameter provided in the CG configuration (e.g., srs-ResourceIndicator). If only one SRS resource is configured in the SRS resource set with the usage in the SRS-ResourceSet set to ‘codebook’, the SRS resource may be the SRS resource configured in the SRS resource set.
In some implementations, if a UE receives a DCI format 0_1 or 0_2 that indicates an activation of a Type-2 CG configuration, the UE may perform PUSCH transmissions periodically, where the period may be provided by a parameter in the CG configuration (e.g., periodicity, periodicityExt-r16, or periodicityExt-r17), perform precoding to each PUSCH based on the TPMI indicated by the first TPMI field with the number of layers indicated by the first TPMI field, and perform the PUSCH transmissions using the beam associated with an SRS resource. If more than one SRS resource is configured in the SRS resource set with the usage set to ‘codebook’, the SRS resource may be indicated by the first SRI field. If only one SRS resource is configured in the SRS resource set with the usage in the SRS-ResourceSet set to ‘codebook’, the SRS resource may be the SRS resource configured in the SRS resource set.
In some implementations, the beam may be provided by the spatial relation information (e.g., SRS-SpatialRelationInfo), a UL TCI state, or a joint TCI state, where the spatial relation information, the UL TCI state, or the joint TCI state is associated with the associated SRS resource.

If the UE is configured with two SRS resource sets in the srs-ResourceSetToAddModList or the srs-ResourceSetToAddModListDCI-0-2 with the usage set to ‘codebook’, at least one of the following implementations may occur:
In some implementations, the UE may determine that a first SRI field exists in the DCI (e.g., the DCI format 0_1, the DCI format 0_2, or other DCI formats) if there is more than one SRS resource configured in the first SRS resource set, and the UE may determine that the first SRI field does not exist if there is only one SRS resource configured in the first SRS resource set.
In some implementations, the UE may determine that a second SRI field exists in the DCI (e.g., the DCI format 0_1, the DCI format 0_2, or other DCI formats) if there is more than one SRS resource configured in the second SRS resource set, and the UE may determine that the second SRI field does not exist if there is only one SRS resource configured in the second SRS resource set.
In some implementations, the UE may determine that a first TPMI field (e.g., the precoding information and number of layers field) exists in the DCI (e.g., the DCI format 0_1, the DCI format 0_2, or other DCI formats). The UE may determine the size of the first TPMI field and the table with which the first TPMI field is associated based on at least one of a full power mode configuration, a maximum rank configuration, a transform precoder configuration, and a codebook subset configuration. The full power mode configuration may be “full power mode”, “full power mode 1”, or “full power mode 2”. The maximum rank configuration may be provided by a higher-layer parameter, such as the maxRank or maxRank-sTRP. The maxRank-sTRP may be used when the SRS resource set indicator indicates to the UE to transmit a PUSCH (e.g., on one panel) to one TRP or when the SRS resource set indicator indicates that the PUSCH is associated with the first SRS resource set. In some implementations, when the maxRank-sTRP is configured, the UE may ignore the maxRank and use the maxRank-sTRP to determine the size of the first TPMI field. In some implementations, when a parameter maxRank-SDM or maxRank-SDM2 is configured, which will be described in the “mTRP PUSCH operation” in the present disclosure, the UE may ignore the maxRank-sTRP and use the maxRank to determine the size of the first TPMI field. The transform precoder configuration may be ‘enabled’, which instructs the UE to apply the transform precoder to the PUSCH transmission, or ‘disabled’, which instructs the UE not to apply the transform precoder to the PUSCH transmission. The codebook subset configuration may be “fully and partially and non-coherent”, “partially and non-coherent”, or “non-coherent”.
In some implementations, the UE may determine that a second TPMI field exists in the DCI (e.g., the DCI format 0_1, the DCI format 0_2, or other DCI formats). The UE may determine the size of the second TPMI field and the table with which the second TPMI field is associated based on at least one of a full power mode configuration, a maximum rank configuration, a transform precoder configuration, and a codebook subset configuration. The full power mode configuration may be “full power mode”, “full power mode 1”, or “full power mode 2”. The maximum rank configuration may be provided by a higher-layer parameter, such as maxRank or maxRank-sTRP. The maxRank-sTRP may be used when the SRS resource set indicator indicates to the UE to transmit a PUSCH (e.g., on one panel) to one TRP or when the SRS resource set indicator indicates that the PUSCH is associated with the first SRS resource set. In some implementations, when the maxRank-sTRP is configured, the UE may ignore the maxRank and use the maxRank-sTRP to determine the size of the second TPMI field. In some implementations, when the maxRank-SDM or maxRank-SDM2 is configured, the UE may ignore the maxRank-sTRP and use the maxRank to determine the size of the second TPMI field. The transform precoder configuration may be ‘enabled’, which instructs the UE to apply the transform precoder to the PUSCH transmission, or ‘disabled’, which instructs the UE not to apply the transform precoder to the PUSCH transmission. The codebook subset configuration may be “fully and partially and non-coherent”, “partially and non-coherent”, or “non-coherent”.
In some implementations, if a UE receives, from the serving cell, a DCI (e.g., the DCI format 0_1 or 0_2) scheduling a PUSCH and a field (e.g., SRS resource set indicator) in the DCI indicates that the PUSCH is associated with the first/second SRS resource, the UE may determine its PUSCH transmission precoder based on the first/second TPMI field and the first/second SRI, and perform the PUSCH transmission using the beam provided by an SRS resource. If more than one SRS resource is configured in the first/second SRS resource set with the usage in the SRS-ResourceSet set to ‘codebook’, the SRS resource may be indicated by the first/second SRI field. If only one SRS resource is configured in the first/second SRS resource set with the usage in the SRS-ResourceSet set to ‘codebook’, the SRS resource may be the SRS resource configured in the first/second SRS resource set.
In some implementations, if a UE is provided with a Type-1 CG configuration, the UE may perform the PUSCH transmission periodically, where the period may be provided by a parameter in the CG configuration (e.g., periodicity, periodicityExt-r16, or periodicityExt-r17), perform precoding to each PUSCH based on the TPMI configured by a parameter provided in the CG configuration (e.g., precodingAndNumberOfLayers) with the number of layers configured by a parameter provided in the CG configuration (e.g., precodingAndNumberOfLayers), and perform the PUSCH transmissions using the beam associated with an SRS resource. If more than one SRS resource is configured in the first SRS resource set with the usage in the SRS-ResourceSet set to ‘codebook’, the SRS resource may be indicated by a parameter provided in the CG configuration (e.g., srs-ResourceIndicator). If only one SRS resource is configured in the first SRS resource set with the usage in the SRS-ResourceSet set to ‘codebook’, the SRS resource may be the SRS resource configured in the first SRS resource set.
In some implementations, if a UE receives, from the serving cell, a DCI format 0_1 or 0_2 that indicates an activation of a Type-2 CG configuration, the UE may perform PUSCH transmissions periodically, where the period may be provided by a parameter in the CG configuration (e.g., periodicity, periodicityExt-r16, or periodicityExt-r17), perform precoding to each PUSCH based on the TPMI indicated by the first/second TPMI field with the number of layers indicated by the first/second TPMI field, and perform the PUSCH transmissions using the beam associated with an SRS resource. If more than one SRS resource is configured in the SRS resource set with the usage in the SRS-ResourceSet set to ‘codebook’, the SRS resource may be indicated by the first/second SRI field. If only one SRS resource is configured in the first/second SRS resource set with the usage in the SRS-ResourceSet set to ‘codebook’, the SRS resource may be the SRS resource configured in the first/second SRS resource set.
In some implementations, the beam may be provided by the spatial relation information, (e.g., SRS-SpatialRelationInfo), a UL TCI state, or a joint TCI state, where the spatial relation information, the UL TCI state, or the joint TCI state is associated with the corresponding SRS resource.

In some implementations, if a UE is provided with the txConfig and the txConfig=‘nonCodebook’, the UE may be configured with one or more SRS resource sets in the srs-ResourceSetToAddModList or the srs-ResourceSetToAddModListDCI-0-2 with the usage in the SRS-ResourceSet set to ‘nonCodebook’.

If the UE is configured with only one SRS resource set in the srs-ResourceSetToAddModList or the srs-ResourceSetToAddModListDCI-0-2 with the usage in the SRS-ResourceSet set to ‘nonCodebook’, at least one of the following implementations may occur:
In some implementations, the UE may determine that a first SRI field exists in the DCI (e.g., the DCI format 0_1, the DCI format 0_2, or other DCI formats).
In some implementations, if a UE receives a DCI format 0_1 or 0_2 scheduling a PUSCH, the UE may calculate the precoder used for the SRS transmission based on a measurement of an associated NZP CSI-RS resource, where the SRS resource(s) of the SRS transmission may be indicated by the first SRI field, and the UE may apply the precoder to the PUSCH transmission and perform the PUSCH transmission using the beam provided by the SRS resource(s) indicated by the first SRI field.
In some implementations, if a UE is provided with a Type-1 CG configuration, the UE may perform the PUSCH transmission periodically, where the period may be provided by a parameter in the CG configuration (e.g., periodicity, periodicityExt-r16, or periodicityExt-r17). The UE may calculate the precoder used for the SRS transmission based on a measurement of an associated NZP CSI-RS resource, where the SRS resource(s) of the SRS transmission may be based on a parameter provided in the CG configuration (e.g., srs-ResourceIndicator). The UE may apply the precoder to the PUSCH transmissions and perform the PUSCH transmissions using the beam associated with the SRS resource(s) indicated by a parameter provided in the CG configuration (e.g., srs-ResourceIndicator).
In some implementations, if a UE receives a DCI format 0_1 or 0_2 that indicates an activation of a Type-2 CG configuration, the UE may perform PUSCH transmissions periodically, where the period may be provided by a parameter in the CG configuration (e.g., periodicity, periodicityExt-r16, or periodicityExt-r17). The UE may calculate the precoder used for the SRS transmission based on a measurement of an associated NZP CSI-RS resource, where the SRS resource(s) of the SRS transmission is indicated by the first SRI field in the DCI. The UE may apply the precoder to the PUSCH transmissions and perform the PUSCH transmissions using the beam associated with the SRS resource(s) indicated by the first SRI

### FIELD

In some implementations, the beam may be provided by the spatial relation information (e.g., SRS-SpatialRelationInfo), a UL TCI state, or a joint TCI state, where the spatial relation information, the UL TCI state, or the joint TCI state is associated with the SRS resource(s).

If the UE is configured with two SRS resource sets in the srs-ResourceSetToAddModList or the srs-ResourceSetToAddModListDCI-0-2 with the usage in the SRS-ResourceSet set to ‘nonCodebook’, at least one of the following implementations may occur:
In some implementations, the UE may determine that a first SRI field exists in the DCI (e.g., the DCI format 0_1, the DCI format 0_2, or other DCI formats).
In some implementations, the UE may determine that a second SRI field exists in the DCI (e.g., the DCI format 0_1, the DCI format 0_2, or other DCI formats).
In some implementations, if a UE receives a DCI format 0_1 or 0_2 scheduling a PUSCH and the SRS resource set indicator indicates that the PUSCH is associated with the first/second SRS resource set, the UE may calculate the precoder used for the SRS transmission based on a measurement of an associated NZP CSI-RS resource, where the SRS resource(s) of the SRS transmission may be indicated by the first/second SRI field, and the UE may perform the PUSCH transmission using the beam provided by either the SRS resource indicated by the first/second SRI field or the only SRS resource if only one SRS resource is configured in the first/second SRS resource set with the usage set to ‘nonCodebook’.
In some implementations, if a UE is provided with a Type-1 CG configuration, the UE may perform the PUSCH transmission periodically, where the period may be provided by a parameter in the CG configuration (e.g., periodicity, periodicityExt-r16, or periodicityExt-r17). The UE may calculate the precoder used for the SRS transmission based on a measurement of an associated NZP CSI-RS resource, where the SRS resource(s) of the SRS transmission is based on a parameter provided in the CG configuration (e.g., srs-ResourceIndicator). The UE may apply the precoder to the PUSCH transmissions and perform the PUSCH transmissions using the beam associated with either the SRS resource indicated by a parameter provided in the CG configuration (e.g., srs-ResourceIndicator) or the only SRS resource if only one SRS resource is configured in the SRS resource set with the usage in the SRS-ResourceSet set to ‘nonCodebook’.
In some implementations, if a UE receives a DCI format 0_1 or 0_2 that indicates an activation of a Type-2 CG configuration, the UE may perform PUSCH transmissions periodically, where the period may be provided by a parameter in the CG configuration (e.g., periodicity, periodicityExt-r16, or periodicityExt-r17). If the SRS resource set indicator indicates that the PUSCHs are associated with the first/second SRS resource set, the UE may calculate the precoder used for the SRS transmission based on a measurement of an associated NZP CSI-RS resource, where the SRS resource(s) of the SRS transmission is indicated by the first/second SRI field in the DCI. The UE may apply the precoder to the PUSCH transmissions and perform the PUSCH transmissions using the beam associated with either the SRS resource indicated by the first/second SRI field or the only SRS resource if only one SRS resource is configured in the first/second SRS resource set with the usage in the SRS-ResourceSet set to ‘nonCodebook’.
In some implementations, the beam may be provided by the spatial relation information (e.g., SRS-SpatialRelationInfo), a UL TCI state, or a joint TCI state, where the spatial relation information, the UL TCI state, or the joint TCI state is associated with the first/second SRS resource.
   mTRP PUSCH Operations
   Capability of UL mTRP PUSCH Operation

In some implementations, a UE may report its capability on its supporting schemes of the single-DCI (S-DCI) based and the multi-DCI (M-DCI) based UL mTRP PUSCH operations to the NW. The reported capability may indicate whether the UE supports the following schemes: the S-DCI-based STxMP PUSCH with SDM scheme, the S-DCI-based STxMP with SFN PUSCH scheme, the S-DCI-based UL mTRP PUSCH with TDM scheme, and/or the M-DCI-based STxMP PUSCH.

In some implementations, the capability on its supporting schemes of the S-DCI-based UL mTRP operation may include one or more UE capability IEs in the UECapabilityInformation message.

In some implementations, a UE may report one or more supporting schemes of the S-DCI-based UL mTRP operation in one IE included in the UECapabilityInformation message.

In some implementations, a UE may report multiple supporting schemes of the S-DCI-based UL mTRP operation where the supporting schemes and corresponding IEs included in the UECapabilityInformation message may be one-to-one mapping.

In some implementations, a UE may report its capability on its supporting schemes of the S-DCI-based UL mTRP operation in response to receiving an RRC message (e.g., the UECapabilityEnquiry message) from the NW. For example, the RAT type, such as NR, NE-DC, and NR-NR DC, may be indicated in the RRC message (e.g., the UECapabilityEnquiry message).

In some implementations, a UE that has reported the support of the S-DCI-based STxMP PUSCH with SDM scheme may be provided with configurations of the S-DCI-based STxMP PUSCH with SDM scheme.

In some implementations, a UE that has reported the support of the S-DCI-based STxMP PUSCH with SDM scheme may be provided with configurations of the S-DCI-based STxMP PUSCH with SFN scheme.

In some implementations, a UE that has reported the support of the S-DCI-based STxMP PUSCH with SDM scheme may be provided with configurations of the S-DCI-based UL mTRP PUSCH with TDM scheme.

In some implementations, a UE that has reported the support of the M-DCI-based STxMP PUSCH may be provided with configurations of the M-DCI-based STxMP PUSCH.

In some implementations, a UE that has reported the support of the S-DCI-based STxMP PUSCH with SFN scheme may be provided with configurations of the S-DCI-based STxMP PUSCH with SFN scheme.

In some implementations, a UE that has reported the support of the S-DCI-based STxMP PUSCH with SFN scheme may be provided with configurations of the S-DCI-based STxMP PUSCH with SDM scheme.

In some implementations, a UE that has reported the support of the S-DCI-based STxMP PUSCH with SFN scheme may be provided with configurations of the S-DCI-based UL mTRP PUSCH with TDM scheme.

In some implementations, a UE that has reported the support of the S-DCI-based UL mTRP PUSCH with TDM scheme may be provided with configurations of the S-DCI-based UL mTRP PUSCH with TDM scheme.

In some implementations, a UE that has reported the support of the S-DCI-based UL mTRP PUSCH with TDM scheme may be provided with configurations of the S-DCI-based STxMP PUSCH with SDM scheme.

In some implementations, a UE that has reported the support of the S-DCI-based UL mTRP PUSCH with TDM scheme may be provided with configurations of the S-DCI-based STxMP PUSCH with SFN scheme.

S-DCI-Based STxMP PUSCH with SDM Scheme (STxMP)

In some implementations, if a UE is provided with the txConfig and the txConfig=‘codebook’ and if the UE is provided (e.g., by higher layers) with an indication/configuration of the S-DCI-based STxMP PUSCH with SDM scheme, the UE may be configured with two SRS resource sets in the srs-ResourceSetToAddModList or the srs-ResourceSetToAddModListDCI-0-2 with the usage in the SRS-ResourceSet set to ‘codebook’. For example, the PHY layer of the UE may be provided by the RRC layer with the indication/configuration of the S-DCI-based STxMP PUSCH with SDM scheme. The UE may receive the indication/configuration of the S-DCI-based STxMP PUSCH with SDM scheme from the NW.

In some implementations, if the UE is not configured with “full power mode 2” by a higher-layer parameter, such as the ul-FullPowerTransmission, the number of ports of an SRS resource in the first SRS resource set and the number of ports of an SRS resource in the second SRS resource set may be either the same or different. The number of ports of all SRS resources in the first or second SRS resource set may be either the same or different.

In some implementations, if the UE is configured with “full power mode 2” by a higher-layer parameter, such as the ul-FullPowerTransmission, the number of ports of an SRS resource in the first SRS resource set and the number of ports of an SRS resource in the second SRS resource set may be either the same or different. The number of ports of all SRS resources in the first or second SRS resource set may be either the same or different.

In some implementations, the SRS resource set with a lower SRS resource set ID may be the first SRS resource set, and the SRS resource set with a higher SRS resource set ID may be the second SRS resource set.

In some implementations, the UE may determine that a first SRI field exists in the DCI (e.g., the DCI format 0_1, the DCI format 0_2, or other DCI formats) if there is more than one SRS resource configured in the first SRS resource set, and the UE may determine that the first SRI field does not exist if there is only one SRS resource configured in the first SRS resource set.

In some implementations, the UE may determine that a second SRI field exists in the DCI (e.g., the DCI format 0_1, the DCI format 0_2, or other DCI formats) if there is more than one SRS resource configured in the second SRS resource set, and the UE may determine that the second SRI field does not exist if there is only one SRS resource configured in the second SRS resource set.

In some implementations, the UE may determine that a 2-bit SRS resource set indicator field exists in the DCI (e.g., the DCI format 0_1, the DCI format 0_2, or other DCI formats).

In some implementations, the UE may determine that a first TPMI field exists in the DCI (e.g., the DCI format 01, the DCI format 0_2, or other DCI formats) if the number of ports of the SRS resource indicated by the first SRI field is not equal to one. The UE may determine the size of the first TPMI field and the table with which the first TPMI field is associated based on at least one of a full power mode configuration, a maximum rank configuration, a transform precoder configuration, and a codebook subset configuration. In some implementations, the UE may determine that the first TPMI field does not exist in the DCI (e.g., the DCI format 01, the DCI format 0_2, or other DCI formats) if the number of ports of the SRS resource indicated by the first SRI field is equal to one.

The full power mode configuration may be “full power mode”, “full power mode 1”, or “full power mode 2”. The maximum rank configuration may be provided by a higher-layer parameter, such as maxRank, maxRank-SDM, or maxRank-SDM1. The maxRank-SDM may be used when the SRS resource set indicator indicates to the UE to transmit two PUSCHs on two panels to two TRPs, or when the SRS resource set indicator indicates that the PUSCH is associated with the first SRS resource set. The maxRank-SDM1 may be used when the SRS resource set indicator indicates to the UE to transmit two PUSCHs on two panels to two TRPs, or when the SRS resource set indicator indicates that the PUSCH is associated with the first SRS resource set. The maxRank-SDM1 may be applied to the first PUSCH associated with the first SRS resource set. In some implementations, when the maxRank-SDM/maxRank-SDM1 is configured, the UE may ignore the maxRank and use the maxRank-SDM/maxRank-SDM1 to determine the size of the first TPMI field. In some implementations, when the maxRank is configured, the UE may ignore the maxRank-SDM/maxRank-SDM1 and use the maxRank to determine the size of the first TPMI field.

In some implementations, when the SDM scheme is configured, the UE may use the maxRank, the ul-FullPowerTransmission, the transformPrecoder, and the number of configured antenna ports to determine the table of the first TPMI field. The UE may use the parameter maxRankSDM and the parameters (e.g., the maxRank, the ul-FullPowerTransmission, the transformPrecoder, and the number of configured antenna ports) to determine the table of the second TPMI field.

The transform precoder configuration may be ‘enabled’, which instructs the UE to apply the transform precoder to the PUSCH transmission, or ‘disabled’, which instructs the UE not to apply the transform precoder to the PUSCH transmission. The codebook subset configuration may be “fully and partially and non-coherent”, “partially and non-coherent”, or “non-coherent”.

In some implementations, the UE may determine that a second TPMI field exists in the DCI (e.g., the DCI format 0_1, the DCI format 0_2, or other DCI formats) if the number of ports of the SRS resource indicated by the first SRI field is equal to one. The UE may determine the size of the second TPMI field and the table with which the second TPMI field is associated based on at least one of a full power mode configuration, a maximum rank configuration, a transform precoder configuration, and a codebook subset configuration. In some implementations, the UE may determine that the second TPMI field does not exist in the DCI (e.g., the DCI format 0_1, the DCI format 0_2, or other DCI formats) if the number of ports of the SRS resource indicated by the first SRI field is equal to one.

The full power mode configuration may be “full power mode”, “full power mode 1”, or “full power mode 2”. The maximum rank configuration may be provided by a higher-layer parameter, such as maxRank, maxRank-SDM, or maxRank-SDM2. The maxRank-SDM may be used when the SRS resource set indicator indicates to the UE to transmit two PUSCHs on two panels to two TRPs. The maxRank-SDM2 may be used when the SRS resource set indicator indicates to the UE to transmit two PUSCHs on two panels to two TRPs or when the SRS resource set indicator indicates that the PUSCH is associated with the first SRS resource set. The maxRank-SDM2 may be applied to the second PUSCH associated with the second SRS resource set. In some implementations, when the maxRank-SDM/maxRank-SDM2 is configured, the UE may ignore the maxRank and use the maxRank-SDM/maxRank-SDM2 to determine the size of the second TPMI field. In some implementations, when the maxRank is configured, the UE may ignore the maxRank-SDM/maxRank-SDM2 and use the maxRank to determine the size of the second TPMI field.

The transform precoder configuration may be ‘enabled’, which instructs the UE to apply the transform precoder to the PUSCH transmission, or ‘disabled’, which instructs the UE not to apply the transform precoder to the PUSCH transmission. The codebook subset configuration may be “fully and partially and non-coherent”, “partially and non-coherent”, or “non-coherent”.

In some implementations, if a UE receives a DCI format 0_1 or 0_2 scheduling two PUSCHs on two panels to two TRPs (for example, a field, such as the SRS resource set indicator field, indicates to the UE to transmit two PUSCHs with the SDM scheme), the UE may determine its PUSCH transmission precoders based on the first and the second TPMI fields and/or the first and the second SRI fields, and the UE may perform the PUSCH transmissions using the first and the second beams associated with a first and a second SRS resources. If more than one SRS resource is configured in the first SRS resource set with the usage in the SRS-ResourceSet set to ‘codebook’, the first SRS resource may be indicated by the first SRI field. If only one SRS resource is configured in the first SRS resource set with the usage in the SRS-ResourceSet set to ‘codebook’, the first SRS resource may be the SRS resource configured in the first SRS resource set. If more than one SRS resource is configured in the second SRS resource set with the usage in the SRS-ResourceSet set to ‘codebook’, the second SRS resource may be indicated by the second SRI field. If only one SRS resource is configured in the second SRS resource set with the usage in the SRS-ResourceSet set to ‘codebook’, the second SRS resource may be the SRS resource configured in the second SRS resource set. The TBs transmitted in the two PUSCHs towards the two TRPs may be different. The UE may generate the TBs with independent TB processing procedures.

In some implementations, if a UE is provided with a Type-1 CG configuration, the UE may perform the PUSCH transmission periodically, where the period may be provided by a parameter in the CG configuration (e.g., periodicity, periodicityExt-r16, or periodicityExt-r17), perform precoding to each PUSCH based on the TPMIs configured by two parameters provided in the CG configuration (e.g., the precodingAndNumberOfLayers and the precodingAndNumberOfLayers2) with the number of layers configured by the two parameters provided in the CG configuration (e.g., the precodingAndNumberOfLayers and the precodingAndNumberOfLayers2), and perform the PUSCH transmissions using a first and a second beams associated with a first and a second SRS resources. For example, the UE may perform a first PUSCH transmission using the first beam and perform a second PUSCH transmission using the second beam.

If more than one SRS resource is configured in the first SRS resource set with the usage in the SRS-ResourceSet set to ‘codebook’, the first SRS resource may be indicated by a parameter provided in the CG configuration (e.g., the srs-ResourceIndicator). If only one SRS resource is configured in the first SRS resource set with the usage in the SRS-ResourceSet set to ‘codebook’, the first SRS resource may be the SRS resource configured in the first SRS resource set. If more than one SRS resource is configured in the second SRS resource set with the usage in the SRS-ResourceSet set to ‘codebook’, the second SRS resource may be indicated by a parameter provided in the CG configuration (e.g., the srs-ResourceIndicator2). If only one SRS resource is configured in the second SRS resource set with the usage in the SRS-ResourceSet set to ‘codebook’, the second SRS resource may be the SRS resource configured in the second SRS resource set. The TBs transmitted in each of the two PUSCHs (e.g., the first PUSCH and the second PUSCH) in a period may be different. The UE may generate the TBs with independent TB processing procedures.

In some implementations, if a UE receives a DCI format (e.g., the DCI format 0_1 or 0_2) that indicates an activation of a Type-2 CG configuration, the UE may perform PUSCH transmissions periodically, where the period may be provided by a parameter in the CG configuration (e.g., periodicity, periodicityExt-r16, or periodicityExt-r17). If the DCI schedules two PUSCHs on two panels to two TRPs (for example, a field, such as the SRS resource set indicator field, indicates to the UE to transmit two PUSCHs with the SDM scheme), the UE may perform precoding to each of the two PUSCHs based on the TPMIs indicated by the first and the second TPMI fields with the number of layers indicated by the first and the second TPMI fields, and perform the PUSCH transmissions using the first and the second beams associated with a first and a second SRS resources.

If more than one SRS resource is configured in the first SRS resource set with the usage in the SRS-ResourceSet set to ‘codebook’, the first SRS resource may be indicated by the first SRI field. If only one SRS resource is configured in the first SRS resource set with the usage in the SRS-ResourceSet set to ‘codebook’, the first SRS resource may be the SRS resource configured in the first SRS resource set. If more than one SRS resource is configured in the second SRS resource set with the usage in the SRS-ResourceSet set to ‘codebook’, the second SRS resource may be indicated by the second SRI field. If only one SRS resource is configured in the second SRS resource set with the usage in the SRS-ResourceSet set to ‘codebook’, the second SRS resource may be the SRS resource configured in the second SRS resource set. The TBs transmitted in each of the two PUSCHs in a period may be different. The UE may generate the TBs with independent TB processing procedures.

In some implementations, the first/second beam may be provided by the spatial relation information (e.g., the SRS-SpatialRelationInfo), a UL TCI state, or a joint TCI state, where the spatial relation information, the UL TCI state, or the joint TCI state is associated with the first/second SRS resource.

In some implementations, if a UE is provided with the txConfig and the txConfig=‘nonCodebook’ and if the UE is provided (e.g., by higher layers) with an indication/configuration of the S-DCI-based STxMP PUSCH with SDM scheme, the UE may be configured with two SRS resource sets in the srs-ResourceSetToAddModList or the srs-ResourceSetToAddModListDCI-0-2 with the usage in the SRS-ResourceSet set to ‘nonCodebook’. For example, the PHY layer of the UE may be provided by the RRC layer with the indication/configuration of the S-DCI-based STxMP PUSCH with SDM scheme. The UE may receive the indication/configuration of the S-DCI-based STxMP PUSCH with SDM scheme from the NW.

In some implementations, the number of SRS resources in the first SRS resource set and the number of SRS resources in the second SRS resource set may be the same.

In some implementations, the number of SRS resources in the first SRS resource set and the number of SRS resources in the second SRS resource set may be different.

In some implementations, the UE may determine that a first SRI field exists in the DCI (e.g., the DCI format 01, the DCI format 0_2, or other DCI formats). In some implementations, the UE may determine the size of the first SRI field based on the first SRS resource set configuration and/or a higher-layer parameter that configures the maximum number of layers for PUSCH transmissions (e.g., the maxMIMO-Layers in the PUSCH-ServingCellConfig).

In some implementations, the UE may determine that a second SRI field exists in the DCI (e.g., the DCI format 0_1, the DCI format 0_2, or other DCI formats). In some implementations, the UE may determine the size of the second SRI field based on the second SRS resource set configuration and/or a higher-layer parameter that configures the maximum number of layers for PUSCH transmissions (e.g., the maxMIMO-Layers in the PUSCH-ServingCellConfig).

In some implementations, the UE may determine that a 2-bit SRS resource set indicator field exists in the DCI (e.g., the DCI format 0_1, the DCI format 0_2, or other DCI formats).

In some implementations, if a UE receives a DCI format 0_1 or 0_2 scheduling two PUSCHs on two panels to two TRPs (for example, a field, such as the SRS resource set indicator field, indicates to the UE to transmit two PUSCHs with the SDM scheme), the UE may calculate the precoder used for the SRS transmissions based on a measurement of two associated NZP CSI-RS resources, where the SRS resource of the SRS transmissions may be indicated by the first and the second SRI fields, and the UE may perform the PUSCH transmissions using the first and the second beams. The first beam may be associated with an SRS resource indicated by the first SRI field or the only SRS resource if only one SRS resource is configured in the first SRS resource set with the usage in the SRS-ResourceSet set to ‘nonCodebook’. The second beam may be associated with an SRS resource indicated by the second SRI field or the only SRS resource if only one SRS resource is configured in the second SRS resource set with the usage in the SRS-ResourceSet set to ‘nonCodebook’. The TBs transmitted in the PUSCHs may be different. The UE may generate the TBs with independent TB processing procedures.

In some implementations, if a UE is provided with a Type-1 CG configuration, the UE may perform the PUSCH transmission periodically, where the period may be provided by a parameter in the CG configuration (e.g., periodicity, periodicityExt-r16, or periodicityExt-r17). The UE may calculate the precoders used for the SRS transmissions based on a measurement of two associated NZP CSI-RS resources, where the indicated SRS resources of the SRS transmissions may be based on two parameters provided in the CG configuration (e.g., the srs-ResourceIndicator and the srs-ResourceIndicator2). The UE may apply the precoders to the PUSCH transmissions and perform the PUSCH transmissions using a first and a second beam.

For example, the UE may perform a first PUSCH transmission using the first beam and perform a second PUSCH transmission using the second beam. The first beam may be associated with an SRS indicated by a parameter provided in the CG configuration (e.g., the srs-ResourceIndicator) or the only SRS resource if only one SRS resource is configured in the first SRS resource set with the usage in the SRS-ResourceSet set to ‘nonCodebook’. The second beam may be associated with an SRS indicated by a parameter provided in the CG configuration (e.g., the srs-ResourceIndicator2) or the only SRS resource if only one SRS resource is configured in the second SRS resource set with the usage in the SRS-ResourceSet set to ‘nonCodebook’. The TBs transmitted in each of the two PUSCHs (e.g., the first PUSCH and the second PUSCH) in a period may be different. The UE may generate the TBs with independent TB processing procedures.

In some implementations, if a UE receives a DCI format 0_1 or 0_2 that indicates an activation of a Type-2 CG configuration, the UE may perform PUSCH transmissions periodically, where the period may be provided by a parameter in the CG configuration (e.g., periodicity, periodicityExt-r16, or periodicityExt-r17). If the DCI schedules two PUSCHs on two panels to two TRPs (for example, a field, such as the SRS resource set indicator field, indicates to the UE to transmit two PUSCHs with the SDM scheme), the UE may calculate the precoders used for the SRS transmissions based on a measurement of two associated NZP CSI-RS resources, where the SRS resources of the SRS transmissions are indicated by the first and the second SRI fields.

The UE may apply the precoders to the PUSCH transmissions and perform the PUSCH transmissions using a first and a second beams. The first beam may be associated with an SRS resource indicated by the first SRI field or the only SRS resource if only one SRS resource is configured in the first SRS resource set with the usage in the SRS-ResourceSet set to ‘nonCodebook’. The second beam may be associated with an SRS resource indicated by the second SRI field or the only SRS resource if only one SRS resource is configured in the second SRS resource set with the usage in the SRS-ResourceSet set to ‘nonCodebook’. The TBs transmitted in each of the two PUSCHs may be different. The UE may generate the TBs with independent TB processing procedures.

In some implementations, the first/second beam may be provided by the spatial relation information (e.g., SRS-SpatialRelationInfo), a UL TCI state, or a joint TCI state, where the spatial relation information, the UL TCI state, or the joint TCI state is associated with the first/second SRS resource.

In some implementations, after receiving a DCI, the UE may determine/recognize that one, two, or more PUSCH transmissions are scheduled by the NW based on the codepoint of the SRS resource set indicator field included in the DCI, if it exists, and the UE may transmit one, two, or more PUSCHs using one, two, or more panels/beams/TCI states to one, two, or more TRPs.

In some implementations, after receiving a Type-1 CG configuration, the UE may determine to transmit one, two, or more PUSCHs periodically based on one or more parameters included in a CG configuration (e.g., the rrc-ConfiguredUplinkGrant and/or the Type-1 CG configuration) and/or the codepoint of the SRS resource set indicator field included in the DCI, if it exists. The period of the PUSCH transmissions may be derived by the UE from the Type-1 CG configuration. The UE may transmit one, two, or more PUSCHs using one, two, or more panels/beams/TCI states to one, two, or more TRPs.

In some implementations, the UE may be provided with a CG configuration. After receiving a DCI activating the CG configuration, the UE may determine to transmit one, two, or more PUSCHs periodically based on one or more parameters included in the CG configuration and the codepoint of the SRS resource set indicator field included in the DCI, if it exists. The period may be derived by the UE from the CG configuration. The other scheduling information may be indicated in the DCI. The UE may transmit one, two, or more PUSCHs using one, two, or more panels/beams/TCI states to one, two, or more TRPs.

The “one, two, or more PUSCH transmissions”, the “one, two, or more panels/beams/TCI states”, or the “one, two, or more TRPs” may be associated, respectively, with one, two, or more SRS resource sets. In some implementations, the one, two, or more TRPs may belong to (or may be associated with) the same cell/BS.

In some implementations, the one, two, or more TRPs may belong to (or may be associated with) different cells/BSs. For example, one TRP is associated with a first PCI of a first cell while another TRP is associated with a second PCI of a second cell, where the first PCI is different from the second PCI and the first cell is different from the second cell.

In some implementations, the STxMP configuration may be a configuration of the (S-DCI) SDM scheme and the STxMP configuration may be provided via dedicated signaling, e.g., RRC signaling. The UE may receive the RRC configuration from the serving cell/BS. In response to receiving the RRC configuration, the UE may be configured with the information elements in the RRC configuration (e.g., the STxMP configuration). In some implementations, the UE may receive an STxMP RRC message/configuration including a first RRC configuration, a second RRC configuration, and/or a third configuration. The first RRC configuration may correspond to the (S-DCI) SDM scheme, the second RRC configuration may correspond to the (S-DCI) SFN scheme, and the third RRC configuration may correspond to the (S-DCI) FDM scheme.

In some implementations, the DCI received by the UE may be a DCI format 0_1, a DCI format 0_2, or a new DCI format providing a UL grant. In some implementations, the DCI may be a DCI format 1_1, a DCI format 1_2, or a new DCI format providing/indicating TCI state(s).

In some implementations, the SRS resource set indicator field may be 2 bits.

In some implementations, a codepoint (e.g., ‘10’) of the SRS resource set indicator field may be used to indicate to the UE to transmit two PUSCHs (e.g., to a first TRP and a second TRP) using a first panel and a second panel, a first beam and a second beam, or a first TCI state and a second TCI state. The first TRP may be associated with the first panel, the first beam, or the first TCI state. The second TRP may be associated with the second panel, the second beam, or the second TCI state.

In some implementations, the TCI state may be a UL TCI state or a joint TCI state.

It should be noted that in the remaining of the present disclosure, cases in which “a UE transmits a PUSCH” may include cases in which the SRS resource set indicator field indicates the first codepoint and/or the second codepoint. Cases in which “a UE transmits two PUSCHs” may include cases in which the SRS resource set indicator field indicates the third codepoint and/or another codepoint.

S-DCI-Based STxMP PUSCH with SFN Scheme (STxMP)

In some implementations, if a UE is provided with the txConfig and the txConfig=‘codebook’, and if the UE is provided with an indication/configuration of the S-DCI-based STxMP PUSCH with SFN scheme, the UE may be configured with two SRS resource sets in the srs-ResourceSetToAddModList or the srs-ResourceSetToAddModListDCI-0-2 with the usage in the SRS-ResourceSet set to ‘codebook’. For example, the PHY layer of the UE may be provided by the RRC layer with the indication/configuration of the S-DCI-based STxMP PUSCH with SFN scheme. The UE may receive the indication/configuration of the S-DCI-based STxMP PUSCH with SFN scheme from the NW.

In some implementations, if the UE is not configured with “full power mode 2” by a higher-layer parameter, such as the ul-FullPowerTransmission, the number of ports of an SRS resource in the first SRS resource set and the number of ports of an SRS resource in the second SRS resource set may be either the same or different. The number of ports of all SRS resources in the first or second SRS resource set may be either the same or different.

In some implementations, if the UE is configured with “full power mode 2” by a higher-layer parameter, such as the ul-FullPowerTransmission, the number of ports of an SRS resource in the first SRS resource set and the number of ports of an SRS resource in the second SRS resource set may be the either the same or different. The number of ports of all SRS resources in the first or second SRS resource set may be either the same or different.

In some implementations, the SRS resource set with a lower SRS resource set ID may be referred to as the first SRS resource set, and the SRS resource set with a higher SRS resource set ID may be referred to as the second SRS resource set.

In some implementations, the UE may determine that a first SRI field exists in the DCI (e.g., the DCI format 0_1, the DCI format 0_2, or other DCI formats) if there is more than one SRS resource configured in the first SRS resource set, and the UE may determine that the first SRI field does not exist if there is only one SRS resource configured in the first SRS resource set. In some implementations, the UE may ignore the first SRI field if there is only one SRS resource configured in the first SRS resource set.

In some implementations, the UE may determine that a second SRI field exists in the DCI (e.g., the DCI format 0_1, the DCI format 0_2, or other DCI formats) if there is more than one SRS resource configured in the second SRS resource set, and the UE may determine that the second SRI field does not exist if there is only one SRS resource configured in the second SRS resource set. In some implementations, the UE may ignore the second SRI field if there is only one SRS resource configured in the second SRS resource set.

In some implementations, the UE may determine that a 2-bit SRS resource set indicator field exists in the DCI (e.g., the DCI format 0_1, the DCI format 0_2, or other DCI formats).

In some implementations, the UE may determine that a first TPMI field exists in the DCI (e.g., the DCI format 0_1, the DCI format 0_2, or other DCI formats). The UE may determine the size of the first TPMI field and the table with which the first TPMI field is associated based on at least one of a full power mode configuration, a maximum rank configuration, a transform precoder configuration, and a codebook subset configuration.

The full power mode configuration may be “full power mode”, “full power mode 1”, or “full power mode 2”. The maximum rank configuration may be provided by a higher-layer parameter, such as maxRank or maxRank-SFN. The maxRank-SFN may be used when the SRS resource set indicator indicates to the UE to transmit two PUSCHs on two panels to two TRPs or when the SRS resource set indicator indicates that the two PUSCHs are associated with the first and the second SRS resource set, respectively. In some implementations, when the maxRank-SFN is configured, the UE may ignore the maxRank and use the maxRank-SFN to determine the size of the first TPMI field. In some implementations, when the maxRank is configured, the UE may ignore the maxRank-SFN and use the maxRank to determine the size of the first TPMI field.

The transform precoder configuration may be ‘enabled’, which instructs the UE to apply the transform precoder to the PUSCH transmission, or ‘disabled’, which instructs the UE not to apply the transform precoder to the PUSCH transmission. The codebook subset configuration may be “fully and partially and non-coherent”, “partially and non-coherent”, or “non-coherent”.

In some implementations, the UE may determine that a second TPMI field exists in the DCI (e.g., the DCI format 0_1, the DCI format 0_2, or other DCI formats). The UE may determine the size of the second TPMI field to be the same as that of the first TPMI field and the table with which the first TPMI field is associated may be the same as the table with which the second TPMI field is associated.

In some implementations, the UE may determine the size of the second TPMI field based on the same factors as those used for determining the size of the first TPMI field. For example, the factors may include at least one of a full power mode configuration, a maximum rank configuration, a transform precoder configuration, and a codebook subset configuration.

In some implementations, the UE may determine that a second TPMI field exists in the DCI (e.g., the DCI format 0_1, the DCI format 0_2, or other DCI formats). The UE may determine the size of the second TPMI field and the table with which the second TPMI field is associated based on at least one of a full power mode configuration, a maximum rank configuration, a transform precoder configuration, and a codebook subset configuration.

The full power mode configuration may be “full power mode”, “full power mode 1”, or “full power mode 2”. The maximum rank configuration may be provided by a higher-layer parameter, e.g., maxRank or maxRank-SFN. The maxRank-SFN may be used when the SRS resource set indicator indicates to the UE to transmit two PUSCHs on two panels to two TRPs or when the SRS resource set indicator indicates that the two PUSCHs are associated with the first and the second SRS resource set, respectively. In some implementations, when the maxRank-SFN is configured, the UE may ignore the maxRank and use the maxRank-SFN to determine the size of the second TPMI field. In some implementations, when the maxRank is configured, the UE may ignore the maxRank-SFN and use the maxRank to determine the size of the second TPMI field.

The transform precoder configuration may be ‘enabled’, which instructs the UE to apply the transform precoder to the PUSCH transmission, or ‘disabled’, which instructs the UE not to apply the transform precoder to the PUSCH transmission. The codebook subset configuration may be “fully and partially and non-coherent”, “partially and non-coherent”, or “non-coherent”.

In some implementations, if a UE receives a DCI format 0_1 or 0_2 scheduling two PUSCHs on two panels to two TRPs (for example, a field, such as the SRS resource set indicator field, indicates to the UE to transmit two PUSCHs with the SFN scheme), the UE may determine its PUSCH transmission precoders based on the first and the second TPMI fields and the first and the second SRI fields, and the UE may perform the PUSCH transmissions using the first and the second beams provided by a first and a second SRS resources. If more than one SRS resource is configured in the first SRS resource set with the usage in the SRS-ResourceSet set to ‘codebook’, the first SRS resource may be indicated by the first SRI field. If only one SRS resource is configured in the first SRS resource set with the usage in the SRS-ResourceSet set to ‘codebook’, the first SRS resource may be the SRS resource configured in the first SRS resource set. If more than one SRS resource is configured in the second SRS resource set with the usage in the SRS-ResourceSet set to ‘codebook’, the second SRS resource may be indicated by the second SRI field. If only one SRS resource is configured in the second SRS resource set with the usage in the SRS-ResourceSet set to ‘codebook’, the second SRS resource may be the SRS resource configured in the second SRS resource set. The TBs transmitted in the two PUSCHs may be the same. The UE may generate and transmit the same TB on the two PUSCHs.

In some implementations, if a UE is provided with a Type-1 CG configuration, the UE may perform the PUSCH transmission periodically, where the period may be provided by a parameter in the CG configuration, perform precoding to each PUSCH based on the TPMIs configured by two parameters provided in the CG configuration (e.g., the precodingAndNumberOfLayers and the precodingAndNumberOfLayers2) with the number of layers configured by the two parameters provided in the CG configuration (e.g., the precodingAndNumberOfLayers and the precodingAndNumberOfLayers2), and perform the PUSCH transmissions using a first and a second beams associated with a first and a second SRS resources. For example, the UE may perform a first PUSCH transmission using the first beam and perform a second PUSCH transmission using the second beam. If more than one SRS resource is configured in the first SRS resource set with the usage in the SRS-ResourceSet set to ‘codebook’, the first SRS resource may be indicated by a parameter provided in the CG configuration (e.g., the srs-ResourceIndicator). If only one SRS resource is configured in the first SRS resource set with the usage in the SRS-ResourceSet set to ‘codebook’, the first SRS resource may be the SRS resource configured in the first SRS resource set. If more than one SRS resource is configured in the second SRS resource set with the usage in the SRS-ResourceSet set to ‘codebook’, the second SRS resource may be indicated by a parameter provided in the CG configuration (e.g., the srs-ResourceIndicator2). If only one SRS resource is configured in the second SRS resource set with the usage in the SRS-ResourceSet set to ‘codebook’, the second SRS resource may be the SRS resource configured in the second SRS resource set. The TBs transmitted in each of the two PUSCHs (e.g., the first PUSCH and the second PUSCH) in a period may be different. The UE may generate the TBs with independent TB processing procedures.

In some implementations, if a UE receives a DCI (e.g., the DCI format 0_1 or 0_2) that indicates an activation of a Type-2 CG configuration, the UE may perform PUSCH transmissions periodically, where the period may be provided by a parameter in the CG configuration. If the DCI schedules two PUSCHs on two panels to two TRPs (for example, a field, such as the SRS resource set indicator field, indicates to the UE to transmit two PUSCHs with the SFN scheme), the UE may perform precoding to each of the two PUSCHs based on the TPMIs indicated by the first and the second TPMI fields with the number of layers indicated by the first and the second TPMI fields, and perform the PUSCH transmissions using a first and a second beams associated with a first and a second SRS resources.

If more than one SRS resource is configured in the first SRS resource set with the usage in the SRS-ResourceSet set to ‘codebook’, the first SRS resource may be indicated by the first SRI field. If only one SRS resource is configured in the first SRS resource set with the usage in the SRS-ResourceSet set to ‘codebook’, the first SRS resource may be the SRS resource configured in the first SRS resource set. If more than one SRS resource is configured in the second SRS resource set with the usage in the SRS-ResourceSet set to ‘codebook’, the second SRS resource may be indicated by the second SRI field. If only one SRS resource is configured in the second SRS resource set with the usage in the SRS-ResourceSet set to ‘codebook’, the second SRS resource may be the SRS resource configured in the second SRS resource set. The TBs transmitted in each of the two PUSCHs in a period may be different. The UE may generate the TBs with independent TB processing procedures.

In some implementations, the beam may be provided by the spatial relation information (e.g., the SRS-SpatialRelationInfo), a UL TCI state, or a joint TCI state, where the spatial relation information, the UL TCI state, or the joint TCI state is associated with the SRS resource.

In some implementations, if a UE is provided with the txConfig and the txConfig=‘nonCodebook’ and if the UE is provided (e.g., by higher layers) an indication/configuration of the S-DCI-based STxMP PUSCH with SFN scheme, the UE may be configured with two SRS resource sets in the srs-ResourceSetToAddModList or the srs-ResourceSetToAddModListDCI-0-2 with the usage in the SRS-ResourceSet set to ‘nonCodebook’. For example, the PHY layer of the UE may be provided by the RRC layer with the indication/configuration of the S-DCI-based STxMP PUSCH with SFN scheme. The UE may receive the indication/configuration of the S-DCI-based STxMP PUSCH with SFN scheme from the NW.

In some implementations, the number of SRS resources in the first SRS resource set and the number of SRS resources in the second SRS resource set may be the same.

In some implementations, the number of SRS resources in the first SRS resource set and the number of SRS resources in the second SRS resource set may be different.

In some implementations, the number of ports of an SRS resource in one of the two SRS resource sets may be the same as the number of ports of an SRS resource in the other SRS resource set.

In some implementations, the UE may determine that a first SRI field exists in the DCI (e.g., the DCI format 0_1, the DCI format 0_2, or other DCI formats) if there is more than one SRS resource configured in the first SRS resource set. The UE may determine that the first SRI field does not exist if there is only one SRS resource configured in the first SRS resource set. In some implementations, the UE may ignore the first SRI field if there is only one SRS resource configured in the first SRS resource set.

In some implementations, the UE may determine that a second SRI field exists in the DCI (e.g., the DCI format 0_1, the DCI format 0_2, or other DCI formats) if there is more than one SRS resource configured in the second SRS resource set. The UE may determine that the second SRI field does not exist if there is only one SRS resource configured in the second SRS resource set. In some implementations, the UE may ignore the second SRI field if there is only one SRS resource configured in the second SRS resource set.

In some implementations, the UE may determine that the size of the second SRI field is the same as that of the first SRI field.

In some implementations, the UE may determine the size of the first SRI field based on the first SRS resource set configuration and/or a higher-layer parameter that configures the maximum number of layers for PUSCH transmissions (e.g., the maxMIMO-Layers in the PUSCH-ServingCellConfig). The UE may determine the size of the second SRI field based on the second SRS resource set configuration and/or the higher-layer parameter that configures the maximum number of layers for PUSCH transmissions (e.g., the maxMIMO-Layers in the PUSCH-ServingCellConfig). The size of the first SRI field and the size of second SRI field may be different.

In some implementations, the UE may determine that a 2-bit SRS resource set indicator field exists in the DCI (e.g., the DCI format 0_1, the DCI format 0_2, or other DCI formats).

In some implementations, if a UE receives a DCI format 0_1 or 0_2 scheduling two PUSCHs on two panels to two TRPs (for example, a field, such as the SRS resource set indicator field, indicates to the UE to transmit two PUSCHs with the SFN scheme), the UE may calculate the precoder used for the SRS transmissions based on a measurement of two associated NZP CSI-RS resources, where the SRS resource of the SRS transmission may be indicated by the first and the second SRI fields, and the UE may perform the PUSCH transmissions using a first and a second beams. The first beam may be associated with an SRS resource indicated by the first SRI field or the only SRS resource if only one SRS resource is configured in the first SRS resource set with the usage in the SRS-ResourceSet set to ‘nonCodebook’. The second beam may be associated with an SRS resource indicated by the second SRI field or the only SRS resource if only one SRS resource is configured in the second SRS resource set with the usage in the SRS-ResourceSet set to ‘nonCodebook’. In some implementations, the TBs transmitted in the two PUSCHs may be different. The UE may generate the TBs with independent TB processing procedures. In some implementations, the TBs carried on the two PUSCHs with the SFN scheme may be the same.

In some implementations, if a UE is provided with a Type-1 CG configuration, the UE may perform the PUSCH transmission periodically, where the period may be provided by a parameter in the CG configuration. The UE may calculate the precoder used for the SRS transmission based on a measurement of two associated NZP CSI-RS resources, where the SRS resource(s) of the SRS transmission may be based on two parameters provided in the CG configuration (e.g., the srs-ResourceIndicator and the srs-ResourceIndicator2). The UE may apply the precoder to the PUSCH transmissions and perform the PUSCH transmissions using a first and a second beams.

For example, the UE may perform a first PUSCH transmission using the first beam and perform a second PUSCH transmission using the second beam. The first beam may be associated with an SRS indicated by a parameter provided in the CG configuration (e.g., the srs-ResourceIndicator) or the only SRS resource if only one SRS resource is configured in the first SRS resource set with the usage in the SRS-ResourceSet set to ‘nonCodebook’. The second beam may be associated with an SRS indicated by a parameter provided in the CG configuration (e.g., the srs-ResourceIndicator2) or the only SRS resource if only one SRS resource is configured in the second SRS resource set with the usage in the SRS-ResourceSet set to ‘nonCodebook’. The TBs transmitted in each of the two PUSCHs (e.g., the first PUSCH and the second PUSCH) in a period may be different. The UE may generate the TBs with independent TB processing procedures.

In some implementations, if a UE receives a DCI format 0_1 or 0_2 that indicates an activation of a Type-2 CG configuration, the UE may perform PUSCH transmissions periodically, where the period may be provided by a parameter in the CG configuration. If the DCI schedules two PUSCHs on two panels to two TRPs (for example, a field, such as the SRS resource set indicator field, indicates to the UE to transmit two PUSCHs with the SFN scheme), the UE may calculate the precoders used for the SRS transmissions based on a measurement of two associated NZP CSI-RS resources, where the SRS resources of the SRS transmissions are indicated by the first and the second SRI fields in the DCI. The UE may apply the precoders to the PUSCH transmissions and perform the PUSCH transmissions using a first and a second beams. The first beam may be associated with an SRS resource indicated by the first SRI field or the only SRS resource if only one SRS resource is configured in the first SRS resource set with the usage in the SRS-ResourceSet set to ‘nonCodebook’. The second beam may be associated with an SRS resource indicated by the second SRI field or the only SRS resource if only one SRS resource is configured in the second SRS resource set with the usage in the SRS-ResourceSet set to ‘nonCodebook’. The TBs transmitted in each of the two PUSCHs in a period may be different. The UE may generate the TBs with independent TB processing procedures.

In some implementations, the first/second beam may be provided by the spatial relation information (e.g., SRS-SpatialRelationInfo), a UL TCI state, or a joint TCI state, where the spatial relation information, the UL TCI state, or the joint TCI state is associated with the first/second SRS resource.

S-DCI-Based TDM Scheme (mTRP)

In some implementations, when two SRS resource sets are configured in the srs-ResourceSetToAddModList or the srs-ResourceSetToAddModListDCI-0-2 with the higher layer parameter usage in the SRS-ResourceSet set to ‘codebook’ or ‘nonCodebook’, and if the UE is not provided with an STxMP configuration or the UE is provided with a configuration(s) of a UL mTRP with the TDM scheme, for PUSCH repetition Type A, in case K>1, the same symbol allocation may be applied across the K consecutive slots and the PUSCH may be limited to a single transmission layer. The UE may repeat the TB across the K consecutive slots applying the same symbol allocation in each slot, and the association between the first and second SRS resource sets in the srs-ResourceSetToAddModList or the srs-ResourceSetToAddModListDCI-0-2 and each slot may be determined as follows:
If the DCI format 0_1 or DCI format 0_2 indicates codepoint “00” for the SRS resource set indicator, the first SRS resource set may be associated with all K consecutive slots.
If the DCI format 0_1 or DCI format 0_2 indicates codepoint “01” for the SRS resource set indicator, the second SRS resource set may be associated with all K consecutive slots.
If the DCI format 0_1 or DCI format 0_2 indicates codepoint “10” for the SRS resource set indicator, the association between the first and second SRS resource sets and the K consecutive slots may be determined as follows:
   When K=2, the first and second SRS resource sets may be applied to the first and second slots of the two consecutive slots, respectively.
   When K>2 and the cyclicMapping in the PUSCH-Config is enabled, the first and second SRS resource sets may be applied to the first and second slots of the K consecutive slots, respectively, and the same SRS resource set mapping pattern may continue to the remaining slots of the K consecutive slots.
   When K>2 and the sequentialMapping in the PUSCH-Config is enabled, the first SRS resource set may be applied to the first and second slots of the K consecutive slots, and the second SRS resource set may be applied to the third and fourth slots of the K consecutive slots, and the same SRS resource set mapping pattern may continue to the remaining slots of the K consecutive slots.
If the DCI format 0_1 or DCI format 0_2 indicates codepoint “11” for the SRS resource set indicator, the association between the first and second SRS resource sets and the K consecutive slots may be determined as follows:
   When K=2, the second and first SRS resource sets may be applied to the first and second slots of the two consecutive slots, respectively.
   When K>2 and the cyclicMapping in the PUSCH-Config is enabled, the second and first SRS resource sets may be applied to the first and second slots of the K consecutive slots, respectively, and the same SRS resource set mapping pattern may continue to the remaining slots of the K consecutive slots.
   When K>2 and the sequentialMapping in the PUSCH-Config is enabled, the second SRS resource set may be applied to the first and second slots of the K consecutive slots, and the first SRS resource set may be applied to the third and fourth slots of the K consecutive slots, and the same SRS resource set mapping pattern may continue to the remaining slots of the K consecutive slots.

For PUSCH repetition Type B, when two SRS resource sets are configured in the srs-ResourceSetToAddModList or the srs-ResourceSetToAddModListDCI-0-2 with the higher layer parameter usage in the SRS-ResourceSet set to ‘codebook’ or ‘nonCodebook’, the association between the SRS resource sets and nominal PUSCH repetitions may be determined using the same method as the association between the SRS resource sets and slots in the PUSCH repetition Type A, except that the nominal repetitions are considered instead of slots.

### M-DCI-Based STxMP

In some implementations, if a UE is provided with a higher layer parameter txConfig and the txConfig is set to ‘codebook’, and if the UE is provided (e.g., by higher layers) with an indication/configuration of the M-DCI-based STxMP, the UE may be configured with two SRS resource sets in the srs-ResourceSetToAddModList or the srs-ResourceSetToAddModListDCI-0-2 with the usage (e.g., in the SRS-ResourceSet) set to ‘codebook’, where the two RRC IEs (e.g., the srs-ResourceSetToAddModList and the srs-ResourceSetToAddModListDCI-0-2) may be configured/indicated to the UE by the gNB/NW via RRC signaling (e.g., in the RRCReconfiguration message). For example, the PHY layer of the UE may be provided by the RRC layer with the indication/configuration of the M-DCI-based STxMP PUSCH. The UE may receive the indication/configuration of the M-DCI-based STxMP PUSCH from the NW.

In some implementations, the indication/configuration of the M-DCI-based STxMP may be a higher-layer parameter indicating which UL mTRP PUSCH scheme (e.g., among the S-DCI-based STxMP PUSCH with SDM scheme, the S-DCI-based STxMP PUSCH with SFN scheme, and the M-DCI-based STxMP PUSCH) is enabled/indicated/configured. For example, the UE may be configured by the gNB/NW with an RRC IE/field, such as “STxMPScheme-r18 ENUMERATED {S-DCI-based STxMP PUSCH with SDM scheme, S-DCI-based STxMP PUSCH with SFN scheme, M-DCI-based STxMP PUSCH, spare}”.

In some implementations, the indication/configuration of the M-DCI-based STxMP may be a set of higher-layer parameters, such as including one or more higher-layer parameters. The set of higher-layer parameters may include at least one of the following:
Two different values of the CORESET pool index for two CORESETs among the CORESETs configured to the UE.
A higher-layer parameter which may be STxMPScheme-r18 ENUMERATED {S-DCI-based STxMP PUSCH with SDM scheme, S-DCI-based STxMP PUSCH with SFN scheme, M-DCI-based STxMP PUSCH, spare}.
Two SRS resource sets with the usage set to ‘codebook’.

In some implementations, the SRS resource set with a lower SRS resource set ID may be referred to as the first SRS resource set, and the SRS resource set with a higher SRS resource set ID may be referred to as the second SRS resource set.

In some implementations, the number of SRS resources in the first SRS resource set and the number of SRS resources in the second SRS resource set may be different.

In some implementations, the UE may receive a first DCI format 0_1/0_2 from the NW in a first CORESET and receive a second DCI format 0_1/0_2 from the NW in a second CORESET. In some implementations, the first CORESET may be associated with a first value of the CORESET pool index and the second CORESET may be associated with a second value of the CORESET pool index.

In some implementations, the value of the CORESET pool index may be 0 or 1.

In some implementations, the first value of the CORESET pool index may be different from the second value of the CORESET pool index.

In some implementations, the UE may receive the second DCI format 0_1/0_2 later than the first DCI format 0_1/0_2.

In some implementations, the UE may receive the first DCI format 0_1/0_2 later than the second DCI format 0_1/0_2.

In some implementations, the UE may receive the first DCI format 0_1/0_2 and the second DCI format 0_1/0_2 simultaneously.

In some implementations, the CRC of the first/second DCI format 0_1/0_2 may be scrambled by the C-RNTI or the MCS-C-RNTI.

In some implementations, the CRC of the first/second DCI format 0_1/0_2 may be scrambled by the CS-RNTI.

In some implementations, if the UE is configured with the SSB-MTC-AdditionalPCI, the first CORESET pool index may be associated with the serving cell PCI, and the second CORESET pool index may be associated with a PCI other than the serving cell PCI.

In some implementations, the first DCI format 0_1/0_2 may be received in a first serving cell, and the second DCI format 0_1/0_2 may be received in a second serving cell. In some implementations, the first serving cell and the second serving cell may belong to the same cell group. In some implementations, the first serving cell and the second serving cell may belong to different cell groups.

In some implementations, the first value of the CORESET pool index may be associated with the first panel, and the second value of the CORESET pool index may be associated with the second panel.

In some implementations, the UE may receive the first DCI format 0_1/0_2 and the second DCI format 0_1/0_2 within the same CORESET from the NW.

In some implementations, the UE may determine whether or not an SRI field is included in the first DCI format 0_1/0_2 and the second DCI format 0_1/0_2. In some implementations, the UE may determine the size of the SRI field in each DCI format associated with different CORESET pool indices based on the number of SRS resources configured to each SRS resource set associated with different CORESET pool indices, where the parameter usage of each SRS resource set is set to ‘codebook’.

In some implementations, the UE may determine the size/number of bits of the SRI field as max{┌log₂(N_{SRS,1})┐, ┌log₂(N_{SRS,2})┐} bits, where N_{SRS,1} is the number of SRS resources in the first SRS resource set, N_{SRS,2} is the number of SRS resources in the second SRS resource set, and max{A, B} is the maximum of A and B. If N_{SRS,1} is 1, the UE may determine that the size of the SRI field associated with the first SRS resource set may be zero bit. If N_{SRS, 2} is 1, the UE may determine that the size of the SRI field associated with the second SRS resource set is zero bit.

In some implementations, if N_{SRS,1} and N_{SRS,2} are not equal, the UE may determine the size/number of bits of the SRI field as max{┌log₂(N_{SRS, 1})┐, ┌log₂(N_{SRS, 2})┐} bits. If N_{SRS,1} and N_{SRS,2} are equal, the UE may determine the size/number of bits of the SRI field as ┌log₂(N_{SRS,1})┐ or ┌log₂(N_{SRS, 2})┐ bits.

In some implementations, if different SRS resource sets with different number of SRS resources are configured, the bit-width/size/number of bits of the SRI field may be determined based on the maximum number SRS resources among the configured SRS resource sets with the usage set to ‘codebook’. If the number of SRS resources in a first SRS resource set is less than the number of SRS resources in a second SRS resource set among the configured SRS resource sets, one or more bits with value set to ‘0’ may be inserted at the MSB(s) of the SRI field in the first DCI format 0_1/0_2 until the bit-width of the SRI field in the first DCI format 0_1/0_2 is equal to the bit-width of the SRI field in the second DCI format 0_1/0_2.

In some implementations, if the size of the SRI field is determined as a non-zero number of bits according to max{┌log₂(N_{SRS,1})┐, ┌log₂(N_{SRS,2})┐}, ┌log₂(N_{SRS,1})┐, or ┌log₂(N_{SRS, 2})┐, the UE may determine that the SRI field is included in the first DCI format 0_1/0_2.

In some implementations, if the size of the SRI field is determined as zero bit according to max{┌log₂(N_{SRS, 1})┐, ┌log₂(N_{SRS,2})┐}, ┌log₂(N_{SRS,1})┐, or ┌log₂(N_{SRS,2})┐, the UE may determine that the SRI field is not included in the first DCI format 0_1/0_2.

In some implementations, if ┌log₂(N_{SRS,1})┐ is greater/larger than ┌log₂(N_{SRS, 2})┌, for the first DCI format 0_1/0_2, the UE may interpret the SRI field based on all bits (e.g., ┌log₂(N_{SRS, 1})┐) of the SRI field when determining which SRS resource the SRI field indicates, and for the second DCI format 0_1/0_2, the UE may interpret the SRI field based on the first/leftmost ┌log₂(N_{SRS, 2})┐ bits, the last/rightmost ┌log₂(N_{SRS, 2})┐ bits, the ┌log₂(N_{SRS, 2})┐ MSBs, or the ┌log₂(N_{SRS, 2})┐ LSBs of the SRI field.

In some implementations, if ┌log₂(N_{SRS, 1})┐ is less/smaller than ┌log₂(N_{SRS, 2})┐, for the first DCI format 0_1/0_2, the UE may interpret the SRI field based on the first/leftmost ┌log₂(N_{SRS,1})┐ bits or the last/rightmost ┌log₂(N_{SRS, 1})┐ bits of the SRI field when determining which SRS resource the SRI field indicates, and for the second DCI format 0_1/0_2, the UE may interpret the SRI field based on all bits (e.g., ┌log₂(N_{SRS, 2})┐) of the SRI field.

In some implementations, the UE may determine a first TCI state/beam/spatial domain filter that may be applied to the PUSCH transmission(s) scheduled by the first DCI format 0_1/0_2 and/or associated with the first SRS resource set based on the most recent transmission of the SRS resource in the first SRS resource set identified/indicated by the SRI field in the first DCI format 0_1/0_2, where the SRS resource is prior to (the reception of) the first DCI format 0_1/0_2.

In some implementations, the UE may determine a second TCI state/beam/spatial domain filter that may be applied to the PUSCH transmission(s) scheduled by the second DCI format 0_1/0_2 and/or associated with the second SRS resource set based on the most recent transmission of the SRS resource in the second SRS resource set identified/indicated by the SRI field in the second DCI format 0_1/0_2, where the SRS resource is prior to (the reception of) the second DCI format 0_1/0_2.

In some implementations, the UE may determine whether or not a TPMI field is included in the first DCI format 0_1/0_2 and the second DCI format 0_1/0_2.

In some implementations, the UE may determine the size/number of bits of the TPMI field based on at least one of a full power mode configuration, a maximum rank configuration, a transform precoder configuration, a codebook subset configuration, and the maximum number of ports of an SRS resource among the configured SRS resource sets with the usage set to ‘codebook’.

The full power mode configuration may be “full power”, “full power mode 1”, or “full power mode 2”. The maximum rank configuration may be provided by a higher-layer parameter (e.g., the maxRank or the maxRankDCI-0-2). The transform precoder configuration may be ‘enabled’, which instructs the UE to apply the transform precoder to the PUSCH transmission, or ‘disabled’, which instructs the UE not to apply the transform precoder to the PUSCH transmission. The codebook subset configuration may be “fully and partially and non-coherent”, “partially and non-coherent”, or “non-coherent”.

In some implementations, the UE may determine a first precoder that may be applied to the PUSCH transmission(s) scheduled by the first DCI format 0_1/0_2 and/or associated with the first SRS resource set based on the TPMI field in the first DCI format 0_1/0_2 and the TPMI table with which the TPMI field is associated.

In some implementations, the UE may determine a second precoder that may be applied to the PUSCH transmission(s) scheduled by the second DCI format 0_1/0_2 and/or associated with the second SRS resource set based on the TPMI field in the second DCI format 0_1/0_2 and the TPMI table with which the TPMI field is associated.

In some implementations, if the CRC of the first DCI format 0_1/0_2 is scrambled by the C-RNTI or the CS-RNTI, the UE may perform a first PUSCH transmission when a PUSCH repetition is not indicated or a first set of PUSCH transmissions when the PUSCH repetition is indicated. In some implementations, the PUSCH repetition may be indicated by a TDRA field in the first DCI format 0_1/0_2. In some implementations, the PUSCH repetition may be indicated by an RRC parameter in the PUSCH configuration or the configured grant configuration.

In some implementations, if the CRC of the second DCI format 0_1/0_2 is scrambled by the C-RNTI or the CS-RNTI, the UE may perform a second PUSCH transmission when a PUSCH repetition is not indicated or a second set of PUSCH transmissions when the PUSCH repetition is indicated. In some implementations, the PUSCH repetition may be indicated by a TDRA field in the second DCI format 0_1/0_2. In some implementations, PUSCH repetition may be indicated by an RRC parameter in the PUSCH configuration or the configured grant configuration.

In some implementations, if the CRC of the first DCI format 0_1/0_2 is scrambled by the CS-RNTI, the NDI field in the first DCI format 0_1/0_2 is ‘0’, and the UE is provided with a first Type-2 CG configuration, the UE may perform first PUSCH transmissions periodically according to the first Type-2 CG configuration, where the period may be configured by the first Type-2 CG configuration. The first Type-2 CG configuration may be configured to the UE by the NW/gNB via RRC signaling.

In some implementations, if the CRC of the first DCI format 0_1/0_2 is scrambled by the CS-RNTI, the NDI field in the first DCI format 0_1/0_2 is ‘0’, and the UE is provided with a second Type-2 CG configuration, the UE may perform second PUSCH transmissions periodically according to the second Type-2 CG configuration, where the period may be configured by the second Type-2 CG configuration. The second Type-2 CG configuration may be configured to the UE by the NW/gNB via RRC signaling.

In some implementations, the UE may perform first PUSCH transmissions periodically if the UE is configured with a first Type-1 CG configuration, where the period may be configured by the first Type-1 CG configuration. The first Type-1 CG configuration may be configured to the UE by the NW/gNB via RRC signaling.

In some implementations, the UE may perform second PUSCH transmissions periodically if the UE is configured with the second Type-1 CG configuration, where the period may be configured by the second Type-1 CG configuration. The second Type-1 CG configuration may be configured to the UE by the NW/gNB via RRC signaling.

In some implementations, the UE may perform a first CG-based PUSCH transmission or a first group of CG-based PUSCH transmissions based on a first CG configuration (index) and perform a second CG-based PUSCH transmission or a second group of CG-based PUSCH transmissions based on a second CG configuration (index).

In some implementations, the UE may perform multiple PUSCH transmissions scheduled by a single DCI based on an RRC parameter.

In some implementations, the UE may perform the first/first set of PUSCH transmission(s) using the first precoder and the first beam/spatial domain filter.

In some implementations, the UE may perform the second/second set of PUSCH transmission(s) using the second precoder and the second beam/spatial domain filter.

In some implementations, if a UE is provided with a higher layer parameter txConfig and the txConfig=‘nonCodebook’, and if the UE is provided (e.g., by higher layers) with an indication/configuration of the M-DCI-based STxMP, the UE may be configured with two SRS resource sets in the srs-ResourceSetToAddModList or the srs-ResourceSetToAddModListDCI-0-2 with the usage in the SRS-ResourceSet set to ‘nonCodebook’, where the two RRC IEs (e.g., the srs-ResourceSetToAddModList and the srs-ResourceSetToAddModListDCI-0-2) may be configured/indicated to the UE by the gNB/NW via RRC signaling. For example, the PHY layer of the UE may be provided by the RRC layer with the indication/configuration of M-DCI-based STxMP PUSCH. The UE may receive the indication/configuration of the M-DCI-based STxMP PUSCH from the NW. For example, the UE may be configured with an RRC IE/field, by the gNB/NW, such as “STxMPScheme-r18

ENUMERATED {S-DCI-based STxMP PUSCH with SDM scheme, S-DCI-based STxMP PUSCH with SFN scheme, M-DCI-based STxMP PUSCH, spare}”.

In some implementations, the SRS resource set with a lower SRS resource set ID may be referred to as the first SRS resource set, and the SRS resource set with a higher SRS resource set ID may be referred to as the second SRS resource set.

In some implementations, the number of SRS resources in the first SRS resource set and the number of SRS resources in the second SRS resource set may be different.

In some implementations, the UE may receive a first DCI format 0_1/0_2 from the NW in a first CORESET and receive a second DCI format 0_1/0_2 from the NW in a second CORESET. In some implementations, the first CORESET may be associated with a first value of the CORESET pool index and the second CORESET may be associated with a second value of the CORESET pool index.

In some implementations, the value of CORESET pool index may be 0 or 1.

In some implementations, the UE may receive the second DCI format 0_1/0_2 later than the first DCI format 0_1/0_2.

In some implementations, the UE may receive the first DCI format 0_1/0_2 later than the second DCI format 0_1/0_2.

In some implementations, the UE may receive the first DCI format 0_1/0_2 and the second DCI format 0_1/0_2 simultaneously.

In some implementations, the CRC of the first/second DCI format 0_1/0_2 may be scrambled by the C-RNTI or the MCS-C-RNTI.

In some implementations, the CRC of the first/second DCI format 0_1/0_2 may be scrambled by the CS-RNTI.

In some implementations, if the UE is configured with the SSB-MTC-AdditionalPCI, the first CORESET pool index may be associated with the serving cell PCI, and the second CORESET pool index may be associated with a PCI other than the serving cell PCI.

In some implementations, the first CORESET pool index may be associated with the first panel, and the second CORESET pool index may be associated with the second panel.

In some implementations, the UE may determine whether or not an SRI field is included in the first DCI format 0_1/0_2 and the second DCI format 0_1/0_2. In some implementations, the UE may determine the size of the SRI field in each DCI format associated with different CORESET pool indices based on the number of SRS resources configured to each SRS resource set associated with different CORESET pool indices.

In some implementations, the UE may determine the size/number of bits of the SRI field as

$$max \{ ⌈ {log}_{2} ( {\sum }_{k = 1}^{min \{ {L}_{max} , {N}_{SRS , 1} \}} ( \begin{matrix}{N}_{SRS , 1} \\ k\end{matrix} ) ) ⌉ , ⌈ {log}_{2} ( {\sum }_{k = 1}^{min \{ {L}_{max} , {N}_{SRS , 2} \}} ( \begin{matrix}{N}_{SRS , 2} \\ k\end{matrix} ) ) ⌉ \} bits or ⌈ {log}_{2} ( {\sum }_{k = 1}^{min \{ {L}_{max} , max \{ {N}_{SRS , 1} , {N}_{SRS , 2} \} \}} ( \begin{matrix}max \{ {N}_{SRS , 1} , {N}_{SRS , 2} \} \\ k\end{matrix} ) ) ⌉ ,$$

where N_{SRS,1} is the number of SRS resources in the first SRS resource set, N_{SRS,2} is the number of SRS resources in the second SRS resource set as, and max{A, B} is the maximum of A and B. If the UE supports operation with the higher layer parameter maxMIMO-Layers and the maxMIMO-Layers of the PUSCH-ServingCellConfig of the serving cell is configured, Lₘₐₓ may be given by that parameter. Otherwise, Lₘₐₓ may be given by the maximum number of layers for PUSCH supported by the UE for the serving cell for the non-codebook based operation.

The size/number of bits of the SRI field may be

$$max \{ ⌈ {log}_{2} ( {\sum }_{k = 1}^{min \{ {L}_{max} , {N}_{SRS , 1} \}} ( \begin{matrix}{N}_{SRS , 1} \\ k\end{matrix} ) ) ⌉ , ⌈ {log}_{2} ( {\sum }_{k = 1}^{min \{ {L}_{max} , {N}_{SRS , 2} \}} ( \begin{matrix}{N}_{SRS , 2} \\ k\end{matrix} ) ) ⌉ \} bits$$

if N_{SRS,1} is not equal to N_{SRS,2}. The size/number of bits of the SRI field may be

$$⌈ {log}_{2} ( {\sum }_{k = 1}^{min \{ {L}_{max} , {N}_{SRS , 1} \}} ( \begin{matrix}{N}_{SRS , 1} \\ k\end{matrix} ) ) ⌉ or ⌈ {log}_{2} ( {\sum }_{k = 1}^{min \{ {L}_{max} , {N}_{S R S , 2} \}} ( \begin{matrix}{N}_{S R S , 2} \\ k\end{matrix} ) ) ⌉$$

if N_{SRS,1} is equal to N_{SRS,2}.

In some implementations, if different SRS resource sets with different number of SRS resources are configured, the bit-width/size/number of bits of the SRI field may be determined based on the maximum number SRS resources among the configured SRS resource sets with the usage set to ‘nonCodebook’. If the number of SRS resources in an SRS resource set is less than the maximum number of ports in an SRS resource among the configured SRS resources, one or more bits with value set to ‘0’ may be added to the SRI field at the MSB(s).

In some implementations, if the size of the SRI field is determined as a non-zero number of bits according to

$$max \{ ⌈ {log}_{2} ( {\sum }_{k = 1}^{min \{ {L}_{max} , {N}_{SRS , 1} \}} ( \begin{matrix}{N}_{SRS , 1} \\ k\end{matrix} ) ) ⌉ \} , \\ ⌈ {log}_{2} ( {\sum }_{k = 1}^{min \{ {L}_{max} , {N}_{S R S , 2} \}} ( \begin{matrix}{N}_{S R S , 2} \\ k\end{matrix} ) ) ⌉ ,$$

$$⌈ {log}_{2} ( {\sum }_{k = 1}^{min \{ {L}_{max} , {N}_{SRS , 1} \}} ( \begin{matrix}{N}_{SRS , 1} \\ k\end{matrix} ) ) ⌉ , \\ or ⌈ {log}_{2} ( {\sum }_{k = 1}^{min \{ {L}_{max} , {N}_{S R S , 2} \}} ( \begin{matrix}{N}_{S R S , 2} \\ k\end{matrix} ) ) ⌉ ,$$

the UE may determine that the SRI field is included in the first DCI format 0_1/0_2.

In some implementations, if the size of the SRI field is determined as zero bit according to

$$max \{ ⌈ {log}_{2} ( {\sum }_{k = 1}^{min \{ {L}_{max} , {N}_{SRS , 1} \}} ( \begin{matrix}{N}_{SRS , 1} \\ k\end{matrix} ) ) ⌉ , \\ ⌈ {log}_{2} ( {\sum }_{k = 1}^{min \{ {L}_{max} , {N}_{S R S , 2} \}} ( \begin{matrix}{N}_{S R S , 2} \\ k\end{matrix} ) ) ⌉ \} ,$$

$$⌈ {log}_{2} ( {\sum }_{k = 1}^{min \{ {L}_{max} , {N}_{SRS , 1} \}} ( \begin{matrix}{N}_{SRS , 1} \\ k\end{matrix} ) ) ⌉ , \\ or ⌈ {log}_{2} ( {\sum }_{k = 1}^{min \{ {L}_{max} , {N}_{S R S , 2} \}} ( \begin{matrix}{N}_{S R S , 2} \\ k\end{matrix} ) ) ⌉ ,$$

the UE may determine that the SRI field is not included in the first DCI format 0_1/0_2.

In some implementations, if

$$⌈ {log}_{2} ( {\sum }_{k = 1}^{min \{ {L}_{max} , {N}_{SRS , 1} \}} ( \begin{matrix}{N}_{SRS , 1} \\ k\end{matrix} ) ) ⌉$$

is greater than

$$⌈ {log}_{2} ( {\sum }_{k = 1}^{min \{ {L}_{max} , {N}_{S R S , 2} \}} ( \begin{matrix}{N}_{S R S , 2} \\ k\end{matrix} ) ) ⌉ ,$$

for the first DCI format 0_1/0_2 the UE may interpret the SRI field based on all bits (e.g.,

$$⌈ {log}_{2} ( {\sum }_{k = 1}^{min \{ {L}_{max} , {N}_{SRS , 1} \}} ( \begin{matrix}{N}_{SRS , 1} \\ k\end{matrix} ) ) ⌉ )$$

of the SRI field when determining which SRS resource the SRI field indicates, and for the second DCI format 0_1/0_2, the UE may interpret the SRI field based on the first/leftmost

$$⌈ {log}_{2} ( {\sum }_{k = 1}^{min \{ {L}_{max} , {N}_{S R S , 2} \}} ( \begin{matrix}{N}_{S R S , 2} \\ k\end{matrix} ) ) ⌉ bits ,$$

the last/rightmost

$$⌈ {log}_{2} ( {\sum }_{k = 1}^{min \{ {L}_{max} , {N}_{S R S , 2} \}} ( \begin{matrix}{N}_{S R S , 2} \\ k\end{matrix} ) ) ⌉$$

bits, the

$$⌈ {log}_{2} ( {\sum }_{k = 1}^{min \{ {L}_{max} , {N}_{S R S , 2} \}} ( \begin{matrix}{N}_{S R S , 2} \\ k\end{matrix} ) ) ⌉$$

### MSBs, or the

$$⌈ {log}_{2} ( {\sum }_{k = 1}^{min \{ {L}_{max} , {N}_{S R S , 2} \}} ( \begin{matrix}{N}_{S R S , 2} \\ k\end{matrix} ) ) ⌉$$

LSBs of the SRI field.

In some implementations, if

$$⌈ {log}_{2} ( {\sum }_{k = 1}^{min \{ {L}_{max} , {N}_{SRS , 1} \}} ( \begin{matrix}{N}_{SRS , 1} \\ k\end{matrix} ) ) ⌉$$

is less than

$$⌈ {log}_{2} ( {\sum }_{k = 1}^{min \{ {L}_{max} , {N}_{SRS , 1} \}} ( \begin{matrix}{N}_{SRS , 1} \\ k\end{matrix} ) ) ⌉ ,$$

for the first DCI format 0_1/0_2 the UE may interpret the SRI field based on the first/leftmost

$$⌈ {log}_{2} ( {\sum }_{k = 1}^{min \{ {L}_{max} , {N}_{SRS , 1} \}} ( \begin{matrix}{N}_{SRS , 1} \\ k\end{matrix} ) ) ⌉ bits$$

or the last/rightmost

$$⌈ {log}_{2} ( {\sum }_{k = 1}^{min \{ {L}_{max} , {N}_{SRS , 1} \}} ( \begin{matrix}{N}_{SRS , 1} \\ k\end{matrix} ) ) ⌉ bits$$

of the SRI field when determining which SRS resource the SRI field indicates, and for the second DCI format 0_1/0_2, the UE may interpret the SRI field based on all bits (e.g.,

$$⌈ {log}_{2} ( {\sum }_{k = 1}^{min \{ {L}_{max} , {N}_{SRS , 2} \}} ( \begin{matrix}{N}_{SRS , 2} \\ k\end{matrix} ) ) ⌉ )$$

of the SRI field.

In some implementations, the UE may determine a first precoder and a first TCI state/beam/spatial domain filter that may be applied to the PUSCH transmission scheduled by the first DCI format 0_1/0_2 based on the most recent transmission of the SRS resource(s) in the first SRS resource set identified/indicated by the SRI field in the first DCI format 0_1/0_2, where the SRS resource is prior to (the reception of) the first DCI format 0_1/0_2.

In some implementations, the UE may determine a second precoder and a second TCI state/beam/spatial domain filter that may be applied to the PUSCH transmission scheduled by the second DCI format 0_1/0_2 based on the most recent transmission of the SRS resource(s) in the second SRS resource set identified/indicated by the SRI field in the second DCI format 0_1/0_2, where the SRS resource is prior to (the reception of) the second DCI format 0_1/0_2.

In some implementations, the UE may perform a first PUSCH transmission using the first precoder and the first TCI state/beam/spatial domain filter/panel.

In some implementations, the UE may perform a second PUSCH transmission using the second precoder and the second TCI state/beam/spatial domain filter/panel.

Switching Between UL mTRP Schemes

### Configurations of Transmission Scheme

In some implementations, a UE that has reported the support of the S-DCI-based UL mTRP scheme to the NW may be provided with (a) corresponding S-DCI-based UL mTRP configuration(s) by the NW. The S-DCI-based UL mTRP configuration may be a parameter in RRC signaling, and the value of the parameter may be a first value, a second value, or a third value (e.g., ENUMERATED {value1, value2, value3, spare}).

In some implementations, (when two SRS resource sets are configured in the srs-ResourceSetToAddModList or the srs-ResourceSetToAddModListDCI-0-2 with the usage in the SRS-ResourceSet set to ‘codebook’ or ‘nonCodebook’) if the parameter for the S-DCI-based UL mTRP configuration is set to a value indicating that the S-DCI-based STxMP PUSCH with SDM scheme is enabled (e.g., the first value), the UE may interpret the codepoints of the SRS resource set indicator field in the DCI as will be described in “Interpretation of SRS resource set indicator field in DCI for S-DCI-based STxMP PUSCH with SDM scheme” in the present disclosure.

In some implementations, (when two SRS resource sets are configured in the srs-ResourceSetToAddModList or the srs-ResourceSetToAddModListDCI-0-2 with the usage in the SRS-ResourceSet set to ‘codebook’ or ‘nonCodebook’) if the parameter for the S-DCI-based UL mTRP configuration is set to a value indicating that the S-DCI-based STxMP PUSCH with SFN scheme is enabled (e.g., the second value), the UE may interpret the codepoints of SRS resource set indicator field in the DCI as will be described in “Interpretation of SRS resource set indicator field in DCI for S-DCI-based STxMP PUSCH with SFN scheme” in the present disclosure.

In some implementations, (when two SRS resource sets are configured in the srs-ResourceSetToAddModList or the srs-ResourceSetToAddModListDCI-0-2 with the usage in the SRS-ResourceSet set to ‘codebook’ or ‘nonCodebook’) if the parameter for the S-DCI-based UL mTRP configuration is set to a value indicating that the S-DCI-based UL mTRP PUSCH with TDM scheme is enabled (e.g., the third value), the UE may interpret the codepoints of SRS resource set indicator field in the DCI as will be described in “Interpretation of SRS resource set indicator field in DCI for S-DCI-based UL mTRP PUSCH with TDM scheme” in the present disclosure.

In some implementations, (when two SRS resource sets are configured in the srs-ResourceSetToAddModList or the srs-ResourceSetToAddModListDCI-0-2 with the usage in the SRS-ResourceSet set to ‘codebook’ or ‘nonCodebook’) if the UE is not provided with the parameter for the S-DCI-based UL mTRP configuration, the UE may interpret the codepoints of SRS resource set indicator field in the DCI as will be described in “Interpretation of SRS resource set indicator field in DCI for S-DCI-based STxMP PUSCH with SDM scheme” in the present disclosure.

In some implementations, (when two SRS resource sets are configured in the srs-ResourceSetToAddModList or the srs-ResourceSetToAddModListDCI-0-2 with the usage in the SRS-ResourceSet set to ‘codebook’ or ‘nonCodebook’) if the UE is not provided with the parameter for the S-DCI-based UL mTRP configuration, the UE may interpret the codepoints of SRS resource set indicator field in the DCI as will be described in “Interpretation of SRS resource set indicator field in DCI for S-DCI-based STxMP PUSCH with SFN scheme” in the present disclosure.

In some implementations, (when two SRS resource sets are configured in the srs-ResourceSetToAddModList or the srs-ResourceSetToAddModListDCI-0-2 with the usage in the SRS-ResourceSet set to ‘codebook’ or ‘nonCodebook’) if the UE is not provided with the parameter for the S-DCI-based UL mTRP configuration, the UE may interpret the codepoints of SRS resource set indicator field in the DCI as will be described in “Interpretation of SRS resource set indicator field in DCI for S-DCI-based UL mTRP PUSCH with TDM scheme” in the present disclosure.

In some implementations, if the UE is not provided with the parameter for the S-DCI-based UL mTRP configuration, the UE may consider that no S-DCI-based UL mTRP scheme (e.g., the S-DCI-based STxMP PUSCH with SFN scheme, the S-DCI-based STxMP PUSCH with SDM scheme, the S-DCI-based UL mTRP PUSCH with TDM scheme) is configured and/or the UE may not expect to be configured with two SRS resource sets in the srs-ResourceSetToAddModList or the srs-ResourceSetToAddModListDCI-0-2 with the usage in the SRS-ResourceSet set to ‘codebook’ or ‘nonCodebook’.

In some implementations, a UE that has reported the support of the S-DCI-based UL mTRP scheme to the NW may be provided with (a) corresponding S-DCI-based UL mTRP configuration(s) by the NW. Each S-DCI-based UL mTRP configuration may be a parameter in RRC signaling. In some implementations, there may be three parameters.

In some implementations, (when two SRS resource sets are configured in the srs-ResourceSetToAddModList or the srs-ResourceSetToAddModListDCI-0-2 with the usage in the SRS-ResourceSet set to ‘codebook’ or ‘nonCodebook’) if a first parameter for enabling the S-DCI-based STxMP PUSCH with SDM scheme is configured, the UE may interpret the codepoints of SRS resource set indicator field in the DCI as will be described in “Interpretation of SRS resource set indicator field in DCI for S-DCI-based STxMP PUSCH with SDM scheme” in the present disclosure.

In some implementations, (when two SRS resource sets are configured in the srs-ResourceSetToAddModList or the srs-ResourceSetToAddModListDCI-0-2 with the usage in the SRS-ResourceSet set to ‘codebook’ or ‘nonCodebook’) if a second parameter for enabling the S-DCI-based STxMP PUSCH with SFN scheme is configured, the UE may interpret the codepoints of SRS resource set indicator field in the DCI as will be described in “Interpretation of SRS resource set indicator field in DCI for S-DCI-based STxMP PUSCH with SFN scheme” in the present disclosure.

In some implementations, (when two SRS resource sets are configured in the srs-ResourceSetToAddModList or the srs-ResourceSetToAddModListDCI-0-2 with the usage in the SRS-ResourceSet set to ‘codebook’ or ‘nonCodebook’) if a third parameter for enabling the S-DCI-based UL mTRP PUSCH with TDM scheme is configured, the UE may interpret the codepoints of SRS resource set indicator field in the DCI as will be described in “Interpretation of SRS resource set indicator field in DCI for S-DCI-based UL mTRP PUSCH with TDM scheme” in the present disclosure.

In some implementations, (when two SRS resource sets are configured in the srs-ResourceSetToAddModList or the srs-ResourceSetToAddModListDCI-0-2 with the usage in the SRS-ResourceSet set to ‘codebook’ or ‘nonCodebook’) if no parameter among the three parameters (e.g., the parameter(s) for enabling the S-DCI-based STxMP PUSCH with SDM scheme, the S-DCI-based STxMP PUSCH with SFN scheme, and/or the S-DCI-based UL mTRP PUSCH with TDM scheme) is configured, the UE may interpret the codepoints of SRS resource set indicator field in the DCI as will be described in “Interpretation of SRS resource set indicator field in DCI for S-DCI-based STxMP PUSCH with SDM scheme” in the present disclosure.

In some implementations, (when two SRS resource sets are configured in the srs-ResourceSetToAddModList or the srs-ResourceSetToAddModListDCI-0-2 with the usage in the SRS-ResourceSet set to ‘codebook’ or ‘nonCodebook’) if no parameter among the three parameters (e.g., the parameter(s) for enabling the S-DCI-based STxMP PUSCH with SDM scheme, the S-DCI-based STxMP PUSCH with SFN scheme, and/or the S-DCI-based UL mTRP PUSCH with TDM scheme) is configured, the UE may interpret the codepoints of SRS resource set indicator field in the DCI as will be described in “Interpretation of SRS resource set indicator field in DCI for S-DCI-based STxMP PUSCH with SFN scheme” in the present disclosure.

In some implementations, (when two SRS resource sets are configured in the srs-ResourceSetToAddModList or the srs-ResourceSetToAddModListDCI-0-2 with the usage in the SRS-ResourceSet set to ‘codebook’ or ‘nonCodebook’) if no parameter among the three parameters (e.g., the parameter(s) for enabling the S-DCI-based STxMP PUSCH with SDM scheme, the S-DCI-based STxMP PUSCH with SFN scheme, and/or the S-DCI-based UL mTRP PUSCH with TDM scheme) is configured, the UE may interpret the codepoints of SRS resource set indicator field in the DCI as will be described in “Interpretation of SRS resource set indicator field in DCI for S-DCI-based UL mTRP PUSCH with TDM scheme” in the present disclosure.

In some implementations, if no parameter among the three parameters (e.g., the parameter(s) for enabling the S-DCI-based STxMP PUSCH with SDM scheme, the S-DCI-based STxMP PUSCH with SFN scheme, and/or the S-DCI-based UL mTRP PUSCH with TDM scheme) is configured, the UE may consider that no S-DCI-based UL mTRP scheme (e.g., the S-DCI-based STxMP PUSCH with SFN scheme, the S-DCI-based STxMP PUSCH with SDM scheme, the S-DCI-based UL mTRP PUSCH with TDM scheme) is configured and/or the UE may not expect to be configured with two SRS resource sets in the srs-ResourceSetToAddModList or the srs-ResourceSetToAddModListDCI-0-2 with the usage in the SRS-ResourceSet set to ‘codebook’ or ‘nonCodebook’.

In some implementations, the UE may not expect to be provided with more than one UL mTRP configuration.

In some implementations, if the UE is provided with the first parameter, the UE may not expect to be provided with the second and/or the third parameter(s).

In some implementations, if the UE is provided with the second parameter, the UE may not expect to be provided with the first and/or the third parameter(s).

In some implementations, if the UE is provided with the third parameter, the UE may not expect to be provided with the first and/or the second parameter(s).

In some implementations, a UE that has reported the support of the S-DCI-based UL mTRP scheme to the NW may be provided with (a) corresponding S-DCI-based UL mTRP configuration(s) by the NW. Each S-DCI-based UL mTRP configuration may be a parameter set. In some implementations, there may be three parameter sets.

In some implementations, a parameter set may include one or more higher-layer parameters. In some implementations, the parameters within a parameter set may be provided in different RRC IEs.

In some implementations, (when two SRS resource sets are configured in the srs-ResourceSetToAddModList or the srs-ResourceSetToAddModListDCI-0-2 with the usage in the SRS-ResourceSet set to ‘codebook’ or ‘nonCodebook’) if a first parameter set related to/associated with/configuring the S-DCI-based STxMP PUSCH with SDM scheme is configured, the UE may interpret the codepoints of SRS resource set indicator field in the DCI as will be described in “Interpretation of SRS resource set indicator field in DCI for S-DCI-based STxMP PUSCH with SDM scheme” in the present disclosure.

In some implementations, (when two SRS resource sets are configured in the srs-ResourceSetToAddModList or the srs-ResourceSetToAddModListDCI-0-2 with the usage in the SRS-ResourceSet set to ‘codebook’ or ‘nonCodebook’) if a second parameter set related to/associated with/configuring the S-DCI-based STxMP PUSCH with SFN scheme is configured, the UE may interpret the codepoints of SRS resource set indicator field in the DCI as will be described in “Interpretation of SRS resource set indicator field in DCI for S-DCI-based STxMP PUSCH with SFN scheme” in the present disclosure.

In some implementations, (when two SRS resource sets are configured in the srs-ResourceSetToAddModList or the srs-ResourceSetToAddModListDCI-0-2 with the usage in the SRS-ResourceSet set to ‘codebook’ or ‘nonCodebook’) if a third parameter set related to/associated with/configuring the S-DCI-based UL mTRP PUSCH with TDM scheme is configured, the UE may interpret the codepoints of SRS resource set indicator field in the DCI as will be described in “Interpretation of SRS resource set indicator field in DCI for S-DCI-based UL mTRP PUSCH with TDM scheme” in the present disclosure.

In some implementations, (when two SRS resource sets are configured in the srs-ResourceSetToAddModList or the srs-ResourceSetToAddModListDCI-0-2 with the usage in the SRS-ResourceSet set to ‘codebook’ or ‘nonCodebook’) if no parameter set among the three parameter sets (e.g., the parameter set(s) related to the S-DCI-based STxMP PUSCH with SDM scheme, the S-DCI-based STxMP PUSCH with SFN scheme, and/or the S-DCI-based UL mTRP PUSCH with TDM scheme) is configured, the UE may interpret the codepoints of SRS resource set indicator field in the DCI as will be described in “Interpretation of SRS resource set indicator field in DCI for S-DCI-based STxMP PUSCH with SDM scheme” in the present disclosure.

In some implementations, (when two SRS resource sets are configured in the srs-ResourceSetToAddModList or the srs-ResourceSetToAddModListDCI-0-2 with the usage in the SRS-ResourceSet set to ‘codebook’ or ‘nonCodebook’) if no parameter set among the three parameter sets (e.g., the parameter set(s) related to the S-DCI-based STxMP PUSCH with SDM scheme, the S-DCI-based STxMP PUSCH with SFN scheme, and/or the S-DCI-based UL mTRP PUSCH with TDM scheme) is configured, the UE may interpret the codepoints of SRS resource set indicator field in the DCI as will be described in “Interpretation of SRS resource set indicator field in DCI for S-DCI-based STxMP PUSCH with SFN scheme” in the present disclosure.

In some implementations, (when two SRS resource sets are configured in the srs-ResourceSetToAddModList or the srs-ResourceSetToAddModListDCI-0-2 with the usage in the SRS-ResourceSet set to ‘codebook’ or ‘nonCodebook’) if no parameter set among the three parameter sets (e.g., the parameter set(s) related to the S-DCI-based STxMP PUSCH with SDM scheme, the S-DCI-based STxMP PUSCH with SFN scheme, and/or the S-DCI-based UL mTRP PUSCH with TDM scheme) is configured, the UE may interpret the codepoints of SRS resource set indicator field in the DCI as will be described in “Interpretation of SRS resource set indicator field in DCI for S-DCI-based UL mTRP PUSCH with TDM scheme” in the present disclosure.

In some implementations, if no parameter set among the three parameter sets (e.g., the parameter set(s) related to the S-DCI-based STxMP PUSCH with SDM scheme, the S-DCI-based STxMP PUSCH with SFN scheme, and/or the S-DCI-based UL mTRP PUSCH with TDM scheme) is configured, the UE may consider that no S-DCI-based UL mTRP scheme (e.g., the S-DCI-based STxMP PUSCH with SFN scheme, the S-DCI-based STxMP PUSCH with SDM scheme, the S-DCI-based UL mTRP PUSCH with TDM scheme) is configured and/or the UE may not expect to be configured with two SRS resource sets in the srs-ResourceSetToAddModList or the srs-ResourceSetToAddModListDCI-0-2 with the usage in the SRS-ResourceSet set to ‘codebook’ or ‘nonCodebook’.

In some implementations, the UE may not expect to be provided with more than one UL mTRP configuration.

In some implementations, if the UE is provided with the first parameter set, the UE may not expect to be provided with the second and/or the third parameter set(s).

In some implementations, if the UE is provided with the second parameter set, the UE may not expect to be provided with the first and/or the third parameter set(s).

In some implementations, if the UE is provided with the third parameter set, the UE may not expect to be provided with the first and/or the second parameter set(s).

Interpretation of SRS Resource Set Indicator Field in DCI for S-DCI-Based STxMP PUSCH with SDM Scheme

In some implementations, in a case that the UE is configured with the S-DCI-based STxMP SDM scheme and two SRS resource sets in the srs-ResourceSetToAddModList or the srs-ResourceSetToAddModListDCI-0-2 with the usage in the SRS-ResourceSet set to ‘codebook’ or ‘nonCodebook’ (and has reported support for dynamic switching between the S-DCI-based STxMP PUSCH with SDM scheme and the sTRP), the UE may determine that the SRS resource set indicator field in the DCI format 0_0 or DCI format 0_1 is absent (e.g., having 0 bit) if the NW disables the dynamic switching between the S-DCI-based STxMP SDM scheme and other scheme(s) (e.g., sTRP).

In some implementations, in a case that the UE is configured with the S-DCI-based STxMP SDM scheme and (only) one SRS resource set in the srs-ResourceSetToAddModList or the srs-ResourceSetToAddModListDCI-0-2 with the usage in the SRS-ResourceSet set to ‘codebook’ or ‘nonCodebook’ (and has reported support for dynamic switching between the S-DCI-based STxMP PUSCH with SDM scheme and sTRP), the UE may determine that the SRS resource set indicator field in the DCI format 0_0 or DCI format 0_1 is absent (e.g., having 0 bit).

In some implementations, in a case that the UE is configured with the S-DCI-based STxMP SDM scheme and (only) one SRS resource set in the srs-ResourceSetToAddModList or the srs-ResourceSetToAddModListDCI-0-2 with the usage in the SRS-ResourceSet set to ‘codebook’ or ‘nonCodebook’ (and has reported support for dynamic switching between the S-DCI-based STxMP PUSCH with SDM scheme and sTRP), the UE may determine that the SRS resource set indicator field in the DCI format 00 or DCI format 01 is absent (e.g., having 0 bit) even though the NW enables the dynamic switching between the S-DCI-based STxMP SDM scheme and other scheme(s) (e.g., sTRP).

In some implementations, when the UE is configured with the S-DCI-based STxMP SDM scheme and two SRS resource sets in the srs-ResourceSetToAddModList or the srs-ResourceSetToAddModListDCI-0-2 with the usage in the SRS-ResourceSet set to ‘codebook’ or ‘nonCodebook’ (and has reported support for dynamic switching between the S-DCI-based STxMP PUSCH with SDM scheme and the sTRP), the UE may determine that the SRS resource set indicator field exists in the DCI (e.g., the DCI format 0_1, the DCI format 0_2, or other DCI formats).

In some implementations, the SRS resource set indicator field may include 2 bits and may have four codepoints (e.g., ‘00’, ‘01’, ‘10’, and ‘11’).

In some implementations, the first codepoint of the SRS resource set indicator field (e.g., ‘00’) may indicate that the UE transmits (a) PUSCH(s) based on the first TPMI field and/or the first SRI field and the PUSCH(s) may be associated with the first SRS resource set, as described in the section “sTRP PUSCH operations” in the present disclosure.

In some implementations, the second codepoint of the SRS resource set indicator field (e.g., ‘01’) may indicate that the UE transmits (a) PUSCH(s) based on the second TPMI field and/or the second SRI field and the PUSCH(s) may be associated with the second SRS resource set, as described in the section “sTRP PUSCH operations” in the present disclosure.

In some implementations, the third codepoint of the SRS resource set indicator field (e.g., ‘10’ or ‘11’) may indicate that the UE transmits two PUSCHs based on the first and the second TPMI fields and/or the first and the second SRI field. The first PUSCH and the second PUSCH may be associated with the first and the second SRS resource set, respectively, as described in the section “S-DCI-based STxMP PUSCH with SDM scheme” in the present disclosure.

In some implementations, the fourth codepoint of the SRS resource set indicator field (e.g., ‘11’ or ‘10’) may be reserved. The fourth codepoint may not be used for any purpose.

Interpretation of SRS Resource Set Indicator Field in DCI for S-DCI-Based STxMP PUSCH with SFN Scheme

In some implementations, in a case that the UE is configured with the S-DCI-based STxMP SFN scheme and two SRS resource sets in the srs-ResourceSetToAddModList or the srs-ResourceSetToAddModListDCI-0-2 with the usage in the SRS-ResourceSet set to ‘codebook’ or ‘nonCodebook’ (and has reported support for dynamic switching between the S-DCI-based STxMP SFN scheme and sTRP), the UE may determine that the SRS resource set indicator field in the DCI format 0_0 or DCI format 0_1 is absent (e.g., having 0 bit) if the NW disables the dynamic switching between S-DCI-based STxMP SFN scheme and other scheme(s) (e.g., sTRP).

In some implementations, in a case that the UE is configured with the S-DCI-based STxMP SFN scheme and (only) one SRS resource set in the srs-ResourceSetToAddModList or the srs-ResourceSetToAddModListDCI-0-2 with the usage in the SRS-ResourceSet set to ‘codebook’ or ‘nonCodebook’ (and has reported support for dynamic switching between the S-DCI-based STxMP SFN scheme and sTRP), the UE may determine that the SRS resource set indicator field in the DCI format 0_0 or DCI format 0_1 is absent (e.g., having 0 bit).

In some implementations, in a case that the UE is configured with the S-DCI-based STxMP SFN scheme and (only) one SRS resource set in the srs-ResourceSetToAddModList or the srs-ResourceSetToAddModListDCI-0-2 with the usage in the SRS-ResourceSet set to ‘codebook’ or ‘nonCodebook’ (and has reported support for dynamic switching between the S-DCI-based STxMP SFN scheme and sTRP), the UE may determine that the SRS resource set indicator field in the DCI format 0_0 or DCI format 0_1 is absent (e.g., having 0 bit) even though the NW enables the dynamic switching between the S-DCI-based STxMP SFN scheme and other scheme(s) (e.g., sTRP).

In some implementations, when the UE is configured with the S-DCI-based STxMP SFN scheme and two SRS resource sets in the srs-ResourceSetToAddModList or the srs-ResourceSetToAddModListDCI-0-2 with the usage in the SRS-ResourceSet set to ‘codebook’ or ‘nonCodebook’ (and has reported support for dynamic switching between the S-DCI-based STxMP PUSCH with SFN scheme and sTRP), the UE may determine that SRS resource set indicator field exists in the DCI (e.g., the DCI format 0_1, the DCI format 0_2, or other DCI formats).

In some implementations, the SRS resource set indicator field may include 2 bits and may have four codepoints (e.g., ‘00’, ‘01’, ‘10’, and ‘11’).

In some implementations, the first codepoint of the SRS resource set indicator field (e.g., ‘00’) may indicate that the UE transmits (a) PUSCH(s) based on the first TPMI field and/or the first SRI field and the PUSCH(s) may be associated with the first SRS resource set, as described in the section “sTRP PUSCH operations” in the present disclosure.

In some implementations, the second codepoint of the SRS resource set indicator field (e.g., ‘01’) may indicate that the UE transmits (a) PUSCH(s) based on the second TPMI field and/or the second SRI field and the PUSCH(s) may be associated with the second SRS resource set, as described in the section “sTRP PUSCH operations” in the present disclosure.

In some implementations, the third codepoint of the SRS resource set indicator field (e.g., ‘10’ or ‘11’) may indicate that the UE transmits two PUSCHs based on the first and the second TPMI fields and/or the first and the second SRI field. The first PUSCH and the second PUSCH may be associated with the first and the second SRS resource set, respectively, as described in the section “S-DCI-based STxMP PUSCH with SFN scheme” in the present disclosure.

In some implementations, the fourth codepoint of the SRS resource set indicator field (e.g., ‘11’ or ‘10’) may be reserved. The fourth codepoint may not be used for any purpose.

Interpretation of SRS Resource Set Indicator Field in DCI for S-DCI-Based UL mTRP PUSCH with TDM Scheme

In some implementations, when a UE is configured with the S-DCI-based UL mTRP PUSCH with TDM scheme and two SRS resource sets in the srs-ResourceSetToAddModList or the srs-ResourceSetToAddModListDCI-0-2 with the usage in the SRS-ResourceSet set to ‘codebook’ or ‘nonCodebook’, the UE may determine that the SRS resource set indicator field exists in the DCI (e.g., the DCI format 0_1, the DCI format 0_2, or other DCI formats) and may interpret the SRS resource set indicator field and perform PUSCH transmissions as described in in the section “S-DCI-based TDM scheme” in the present disclosure.

### PUCCH Configurations

In some implementations, a UE may be configured with repetition for PUCCH.

In some implementations, the repetition factors may be configured on a per-PUCCH-format basis. In some implementations, the repetition factor of PUCCH resources of a PUCCH format may be provided by a parameter nrofSlots.

In some implementations, the repetition factors may be configured on a per-PUCCH-resource basis. In some implementations, the repetition factor of PUCCH resources of a PUCCH format may be provided by a parameter pucch-RepetitionNrofSlots.

In some implementations, if a PUCCH resource is configured to be transmitted with repetition, the UE may transmit the PUCCH resource in a number of (consecutive) slots, where the number may be provided by the nrofSlots or the pucch-RepetitionNrofSlots.

In some implementations, upon receiving the RRC message (e.g., the RRCReconfiguration message) from the (source) serving cell, the UE may apply the configuration for the repetition for PUCCH (e.g., the repetition for PUCCH, the nrofSlots, the pucch-RepetitionNrofSlots) and configure itself with repetition for PUCCH. The RRC message may include the configuration for the repetition for PUCCH.

In some implementations, if a PUCCH resource is configured to be transmitted with repetition, the UE may transmit the PUCCH resource in a number of (consecutive) slots, where the number may be provided by a field in a DCI format.

In some implementations, a first PUCCH may be scheduled by first DCI in a first CORESET associated with a first CORESET pool index value and a second PUCCH may be scheduled by second DCI in a second CORESET associated with a second CORESET pool index value.

In some implementations, the first CORESET pool index may be associated with the serving cell PCI and the second CORESET pool index may be associated with a PCI other than the serving cell PCI.

In some implementations, the UE may be configured with the STxMP SFN scheme for PUCCH or for a PUCCH resource.

In some implementations, the STxMP SFN scheme may be configured on a per-PUCCH-resource basis. In some implementations, the UE may be configured with a higher-layer parameter (e.g., RRC-layer parameter) in a PUCCH resource configuration indicating that the PUCCH may be transmitted using the STxMP with SFN scheme.

In some implementations, if the higher-layer parameter is configured, the higher-layer parameter indicates the STxMP with SFN scheme, the PUCCH resource includes a first and a second spatial domain filters/spatial settings, and/or the PUCCH resource includes a first and a second sets of power control parameters, the UE may transmit the PUCCH resource with the STxMP SFN scheme, such as transmitting the PUCCH with the two different spatial domain filters/spatial settings.

In some implementations, the two different spatial domain filters/spatial domain settings may be provided by two joint TCI states, two UL TCI states, or two pieces of spatial relation information.

In some implementations, the joint TCI states or the UL TCI states may be configured by RRC signaling, activated by an MAC CE, or indicated by a DCI.

In some implementations, if the higher-layer parameter is not configured, the higher-layer parameter does not indicate the STxMP with SFN scheme, or the higher-layer parameter indicates the sTRP PUCCH, the UE may transmit the PUCCH resource with the sTRP operation, such as transmitting the PUCCH with one spatial domain filter.

In some implementations, if at least one of the following conditions is satisfied: the UE has reported the support of the STxMP SFN for PUCCH, the higher-layer parameter is configured, the higher-layer parameter indicates the STxMP with SFN scheme, and the PUCCH resource includes only one spatial domain filter/spatial setting, the UE may transmit the PUCCH resource with the sTRP scheme, such as using the spatial domain filter/spatial setting.

In some implementations, the spatial domain filter may be provided by a joint TCI state, a UL TCI state, or a spatial relation information.

In some implementations, if at least one of the following conditions is satisfied: the UE has reported the support of STxMP SFN for PUCCH, the higher-layer parameter is not configured, the higher-layer parameter is configured and indicates the STxMP with SFN scheme, and the PUCCH resource includes a first and a second spatial domain filters/spatial settings, the UE may transmit the PUCCH resource with the sTRP scheme, such as using the first or the second spatial domain filter/spatial setting.

In some implementations, the UE may report the support of the STxMP SFN for PUCCH in an RRC message (e.g., the UE-CapabilibyInformation message).

In some implementations, the UE may receive the RRC signaling (e.g., the RRCReconfiguration message) from the (source) serving cell. The RRC signaling may include a configuration for the STxMP SFN scheme for PUCCH or for a PUCCH resource. Upon receiving the RRC signaling including the configuration for the STxMP SFN scheme for PUCCH or for the PUCCH resource, the UE may apply (the parameter associated with) the configuration for the STxMP SFN scheme for PUCCH or for the PUCCH resource.

In some implementations, the UE may receive a dedicated MAC CE for activating the UL TCI state(s) or spatial relation information for the SFN PUCCH.

In some implementations, the UE may receive a MAC CE for indicating unified TCI state(s) corresponding to SFN PUCCH.

In some implementations, the UE may receive a MAC CE that activates and/or deactivates one or two spatial relations (or TCI states) for the PUCCH resource.

In some implementations, the TCI state(s) may be (a) joint TCI state(s) or (an) UL TCI state(s).

In some implementations, the MAC CE may be “PUCCH spatial relation Activation/Deactivation for multiple TRP PUCCH repetition MAC CE”.

In some implementations, the MAC CE may be a dedicated MAC CE for activating the spatial relation or the TCI state for the SFN PUCCH.

In some implementations, the dedicated MAC CE for activating the spatial relation or the TCI state for the SFN PUCCH may include at least one of the following: a first field indicating a serving cell ID, a second field indicating a BWP ID, a third field indicating a PUCCH resource ID, a fourth field indicating a first TCI state ID or a first spatial relation information ID, and a fifth field indicating a second TCI state ID or a second spatial relation information ID.

In some implementations, if the MAC CE includes the first, the second, the third, and the fourth fields, the MAC CE may activate the first spatial domain filter and/or the second spatial domain filter determined by the fourth field.

In some implementations, if the MAC CE includes the first, the second, the third, the fourth, and the fifth fields, the MAC CE may activate the first spatial domain filter determined by the fourth field and the second spatial domain filter determined by the fifth field.

UCI Multiplexing on PUSCH when M-DCI-Based STxMP PUSCH is Configured

In some implementations, a UE configured with the M-DCI-based STxMP PUSCH by the NW may determine to multiplex the UCI in one or two PUSCHs when a PUCCH transmission overlaps with a first PUSCH transmission and a second PUSCH transmission in a slot, where the UCI may be transmitted in the PUCCH.

In some implementations, the UE may receive or may have received a first DCI format 0_1/0_2 from the NW in a first CORESET and the first PUSCH transmission may be scheduled by the first DCI format 0_1/0_2, where the first CORESET may be associated with a first value of the CORESET pool index. The UE may be indicated/configured to perform the first PUSCH transmission using a first spatial domain filter, where the first spatial domain filter may be indicated by the SRI field or a field indicating one or two TCI states in the first DCI format 0_1/0_2.

In some implementations, the UE may receive or may have received a second DCI format 0_1/0_2 from the NW in a second CORESET and the second PUSCH transmission may be scheduled by the second DCI format 0_1/0_2, where the second CORESET may be associated with a second value of the CORESET pool index. The UE may be indicated/configured to perform the second PUSCH transmission using a second spatial domain filter, where the second spatial domain filter may be indicated by the SRI field or a field indicating one or two TCI states in the second DCI format 0_1/0_2.

In some implementations, the values of the CORESET pool index may be 0 or 1.

In some implementations, the first value of the CORESET pool index may be different from the second value of the CORESET pool index.

In some implementations, the PUCCH transmission may be configured by the NW to be transmitted in the STxMP SFN scheme.

In some implementations, the UE may receive, from the gNB/NW, an RRC parameter (e.g., the pucch-RepetitionNrofSlots and/or the nrofSlots) indicating the number of repetitions for the PUCCH transmission. The UE may receive, from the gNB/NW, another RRC parameter for enabling the STxMP SFN scheme for the PUCCH transmission. The UE may perform the STxMP SFN based PUSCH transmission on each PUCCH repetition.

In some implementations, the PUCCH transmission may be configured by the NW to be transmitted with repetition.

In some implementations, the PUCCH transmission may be configured by the NW to be transmitted in the STxMP SFN scheme and with repetition.

In some implementations, the PUCCH transmission may not be configured by the NW to be transmitted in the STxMP SFN scheme and with repetition. For example, the PUCCH transmission may be transmitted in the sTRP scheme without repetition.

In some implementations, the UCI may include HARQ-ACK information, an SR, a CSI report, and/or an LRR.

In some implementations, the UE may multiplex the UCI in the PUSCH in which the UE multiplexes A-CSI report(s). If the UE multiplexes A-CSI report(s) in both PUSCHs, the UE may multiplex the UCI in the PUSCH that is scheduled by the DCI format 0_1/0_2. If both PUSCHs are scheduled by the DCI format 0_1/0_2, the UE may multiplex the UCI in the PUSCH that is transmitted in a serving cell with a lower serving cell ID. If both PUSCHs are transmitted in the same serving cell (with the same serving cell ID), the UE may multiplex the UCI in the earliest/earlier PUSCH that the UE transmits in the slot.

In some implementations, the PUSCH transmission(s) may be configured with one or two TCI states.

In some implementations, if the two PUSCHs start at the same (OFDM) symbol and the PUCCH transmission is configured by the NW to be transmitted in the STxMP SFN scheme without repetition, the UE may multiplex the UCI on the first PUSCH, the second PUSCH, or the first PUSCH and the second PUSCH.

In some implementations, if the two PUSCHs start at the same (OFDM) symbol and the PUCCH transmission is configured by the NW to be transmitted in the STxMP SFN scheme with repetition, the UE may multiplex the UCI on the first PUSCH, the second PUSCH, or the first PUSCH and the second PUSCH. In some implementations, the UE may determine to transmit the two PUSCHs and not to transmit the PUCCH. For example, the UE may determine to drop the PUCCH transmission.

In some implementations, if the two PUSCHs start at the same (OFDM) symbol and the PUCCH transmission is configured by the NW to be transmitted with repetition, the UE may multiplex the UCI on the first PUSCH, the second PUSCH, or the first PUSCH and the second PUSCH. In some implementations, the UE may determine to transmit the two PUSCHs and not to transmit the PUCCH. For example, the UE may determine to drop the PUCCH transmission.

In some implementations, if the two PUSCHs start at the same (OFDM) symbol, the PUCCH transmission is configured by the NW to be transmitted in the STxMP SFN scheme without repetition, the UE is configured with a joint HARQ-ACK feedback mode (e.g., configured with a higher-layer parameter ackNackFeedbackMode set to ‘joint’ or ‘separate’), the UCI includes HARQ-ACK information in response to (a) PDSCH(s) scheduled by the DCI format 1_1/1_2 received in (a) CORESET(s) associated with the first value of CORESET pool index value, and the UCI does not include HARQ-ACK information in response to (a) PDSCH(s) scheduled by the DCI format 1_1/1_2 received in (a) CORESET(s) associated with the second value of CORESET pool index value, the UE may multiplex the UCI on the first PUSCH, the second PUSCH, or the first PUSCH and the second PUSCH. In some implementations, the UE may determine to transmit the two PUSCHs and not to transmit the PUCCH. For example, the UE may determine to drop the PUCCH transmission.

In some implementations, if the two PUSCHs start at the same (OFDM) symbol, the PUCCH transmission is configured by the NW to be transmitted in the STxMP SFN scheme without repetition, the UE is configured with joint or separate HARQ-ACK feedback mode (e.g., configured with a higher-layer parameter ackNackFeedbackMode set to ‘joint’ or ‘separate’), the UCI does not include HARQ-ACK information in response to (a) PDSCH(s) scheduled by the DCI format 1_1/1_2 received in (a) CORESET(s) associated with the first value of CORESET pool index value, and the UCI includes HARQ-ACK information in response to (a) PDSCH(s) scheduled by the DCI format 1_1/1_2 received in (a) CORESET(s) associated with the second value of CORESET pool index value, the UE may multiplex the UCI on the first PUSCH, the second PUSCH, or the first PUSCH and the second PUSCH. In some implementations, the UE may determine to transmit the two PUSCHs and not to transmit the PUCCH. For example, the UE may determine to drop the PUCCH transmission.

In some implementations, if the two PUSCHs start at the same (OFDM) symbol, the PUCCH transmission is configured by the NW to be transmitted in the STxMP SFN scheme without repetition, the UE is configured with joint or separate HARQ-ACK feedback mode (e.g., configured with a higher-layer parameter ackNackFeedbackMode set to ‘joint’ or ‘separate’), the UCI includes HARQ-ACK information in response to (a) PDSCH(s) scheduled by the DCI format 1_1/1_2 received in (a) CORESET(s) associated with the first value of CORESET pool index value, and the UCI includes HARQ-ACK information in response to (a) PDSCH(s) scheduled by the DCI format 1_1/1_2 received in (a) CORESET(s) associated with the second value of CORESET pool index value, the UE may multiplex the UCI on the first PUSCH, the second PUSCH, or the first PUSCH and the second PUSCH. In some implementations, the UE may determine to transmit the two PUSCHs and not to transmit the PUCCH. For example, the UE may determine to drop the PUCCH transmission.

In some implementations, the UE may transmit the PUCCH and the first PUSCH simultaneously.

In some implementations, the UE may transmit the PUCCH and the second PUSCH simultaneously.

In some implementations, if the PUCCH transmission is scheduled by a DCI received in a CORESET associated with the first value of the CORESET pool index and/or the PUCCH resource is configured with repetition, the UE may transmit the PUCCH and the second PUSCH simultaneously and may not transmit the first PUSCH. For example, the UE may determine to drop the first PUSCH transmission.

In some implementations, if the PUCCH transmission is scheduled by a DCI received in a CORESET associated with the second value of the CORESET pool index and/or the PUCCH resource is configured with repetition, the UE may transmit the PUCCH and the first PUSCH simultaneously and may not transmit the second PUSCH. For example, the UE may determine to drop the second PUSCH transmission.

In some implementations, if the first TCI state or spatial relation is activated for the PUCCH resource (e.g., the TCI state for the PUCCH resource is the same as the TCI state indicated/configured for the first PUSCH transmission), the UE may transmit the PUCCH and the second PUSCH simultaneously and may not transmit the first PUSCH. For example, the UE may determine to drop the first PUSCH transmission.

In some implementations, if the second TCI state or spatial relation is activated for the PUCCH resource (e.g., the TCI state for the PUCCH resource is the same as the TCI state indicated/configured for the second PUSCH transmission), the UE may transmit the PUCCH and the first PUSCH simultaneously and may not transmit the second PUSCH. For example, the UE may determine to drop the second PUSCH transmission.

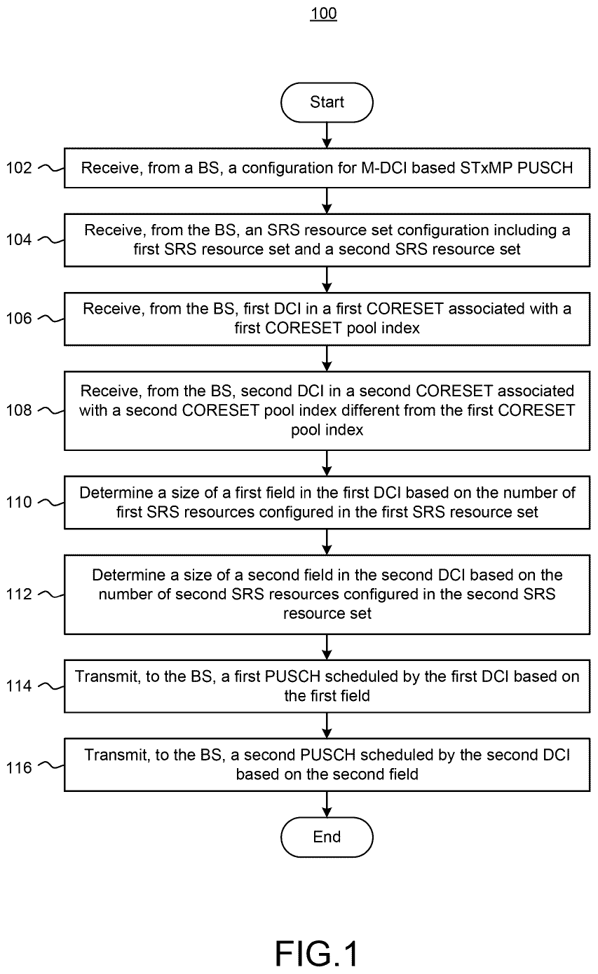

FIG. 1 is a flowchart illustrating a method/process 100 performed by a UE for an STxMP operation, according to an example implementation of the present disclosure. In some implementations, the process 100 may be performed by the UE.

In action 102, the process 100 may start by receiving, from a BS, a configuration for M-DCI based STxMP PUSCH. In action 104, the process 100 may receive, from the BS, an SRS resource set configuration including a first SRS resource set and a second SRS resource set. The first SRS resource set and the second SRS resource set may be used for the same type of UL transmission scheme. The first SRS resource set may be associated with one or more first SRS resources. The second SRS resource set may be associated with one or more second SRS resources.

In action 106, the process 100 may receive, from the BS, first DCI in a first CORESET associated with a first CORESET pool index. In action 108, the process 100 may receive, from the BS, second DCI in a second CORESET associated with a second CORESET pool index different from the first CORESET pool index. Each CORESET pool index may correspond to a TRP. The first DCI may include a DCI format for scheduling a PUSCH transmission, such as the DCI format 00, the DCI format 0_1, the DCI format 0_2, etc. The second DCI may also include a DCI format for scheduling another PUSCH transmission, such as the DCI format 00, the DCI format 0_1, the DCI format 0_2, etc. In some implementations, both the first DCI and the second DCI may be the DCI format 0_1.

In action 110, the process 100 may determine a size of a first field in the first DCI based on the number of first SRS resources configured in the first SRS resource set. The size of the first field may be necessary for the UE to decode the first DCI correctly and to determine the meaning of the first field properly. In action 112, the process 100 may determine a size of a second field in the second DCI based on the number of second SRS resources configured in the second SRS resource set. Similarly, the size of the second field may be necessary for the UE to decode the second DCI correctly and to determine the meaning of the second field properly. The size of the first field and the size of the second field may be determined independently. The size of the first field may be different from the size of the second field. In some implementations, the first field may be a first SRI field, and the second field may be a second SRI field.

In some implementations, the size of the first field may be zero or a positive integer number. For example, if the number of the first SRS resources configured in the first SRS resource set is one, the size of the first field may be zero, which means the first field may be absent in the first DCI. If the number of the first SRS resources configured in the first SRS resource set is eight, the size of the first field may be three (e.g., [log₂(8)]). Similarly, the size of the second field may be zero or a positive integer number. If the number of the second SRS resources configured in the second SRS resource set is one, the size of the second field may be zero, which means the second field may be absent in the second DCI.

In some implementations, the size of the first field in the first DCI may be different from the size of the second field in the second DCI even though the size of the first DCI is the same as the size of the second DCI. For example, additional bits (e.g., with the value set to ‘0’) may be inserted/added to the DCI, using different mechanisms, such as bit padding at the MSBs or LSBs.

In action 114, the process 100 may transmit, to the BS, a first PUSCH scheduled by the first DCI based on the first field. In action 116, the process 100 may transmit, to the BS, a second PUSCH scheduled by the second DCI based on the second field. The process 100 may then end. In some implementations, the first PUSCH and the second PUSCH may overlap in time domain and frequency domain.

In some implementations, both the first SRS resource set and the second SRS resource set may be used for non-codebook-based PUSCH transmission. The first field may indicate a first precoder applied to the first PUSCH. The second field may indicate a second precoder applied to the second PUSCH. For example, the UE may determine the first precoder applied to the first PUSCH scheduled by the first DCI based on an SRS resource indicated by the first field. The UE may determine the second precoder applied to the second PUSCH scheduled by the second DCI based on the an SRS resource indicated by the second field.

In some implementations, both the first SRS resource set and the second SRS resource set may be used for codebook-based PUSCH transmission. The size of the first field may be zero if the number of the first SRS resources configured in the first SRS resource set is one. In a case that the size of the first field is not zero, the first field may indicate a first beam applied to the first PUSCH. The size of the second field may be zero if the number of the second SRS resources configured in the second SRS resource set is one. In a case that the size of the second field is not zero, the second field may indicate a second beam applied to the second PUSCH. In some implementations, an SRS resource may be semi-statically configured with a spatial filter. The UE may determine the first beam applied to the first PUSCH based on a first spatial filter configured for a first SRS resource indicated by the first field. The UE may determine the second beam applied to the second PUSCH based on a second spatial filter configured for a second SRS resource indicated by the second field.

Actions shown in FIG. 1 should not be construed as necessarily order dependent. The order in which the process is described is not intended to be construed as a limitation. Moreover, some of the actions in FIG. 1 may be omitted in some implementations.

The technical problem addressed by the method illustrated in FIG. 1 is how to efficiently perform an STxMP operation, including receiving the SRS resource set configuration and determining the size of the fields in the first DCI and the second DCI based on the first SRS resource set and the second SRS resource set, respectively. This method may help to improve the overall performance of the wireless communication system by reducing the signaling overhead, leading to an enhanced resource allocation and optimization.

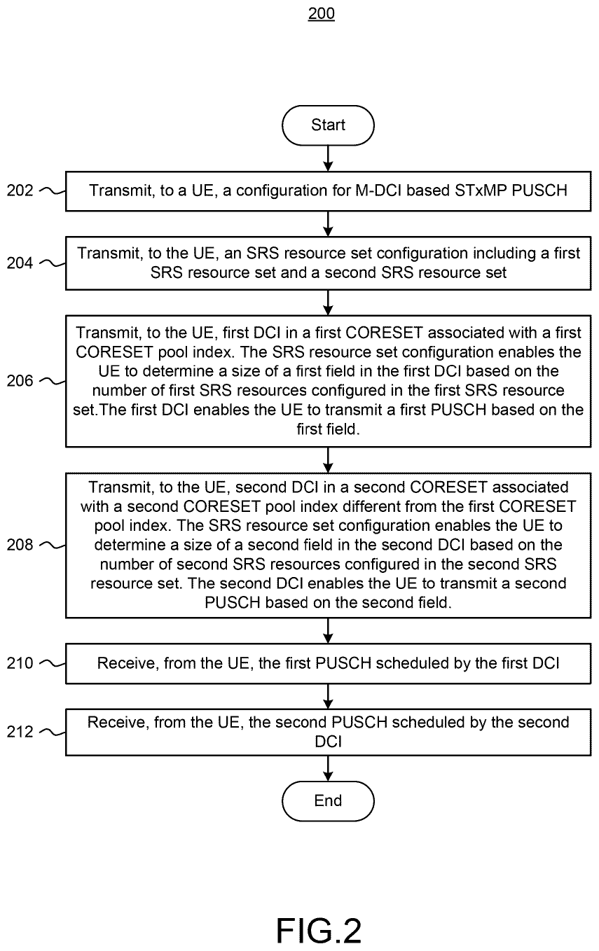

FIG. 2 is a flowchart illustrating a method/process 200 performed by a BS for an STxMP operation, according to an example implementation of the present disclosure. In some implementations, the process 200 may be performed by the BS.

In action 202, the process 200 may start by transmitting, to a UE, a configuration for multi-DCI based STxMP PUSCH. In action 204, the process 200 may transmit, to the UE, an SRS resource set configuration including a first SRS resource set and a second SRS resource set.

In action 206, the process 200 may transmit, to the UE, first DCI in a first CORESET associated with a first CORESET pool index. The SRS resource set configuration may enable the UE to determine a size of a first field in the first DCI based on the number of first SRS resources configured in the first SRS resource set. The first DCI may enable the UE to transmit a first PUSCH based on the first field.

In action 208, the process 200 may transmit, to the UE, second DCI in a second CORESET associated with a second CORESET pool index different from the first CORESET pool index. The SRS resource set configuration may enable the UE to determine a size of a second field in the second DCI based on the number of second SRS resources configured in the second SRS resource set. The second DCI may enable the UE to transmit a second PUSCH based on the second field.

In action 210, the process 200 may receive, from the UE, the first PUSCH scheduled by the first DCI. In action 212, the process 200 may receive, from the UE, the second PUSCH scheduled by the second DCI. The process 200 may then end. The method illustrated in FIG. 2 is similar to that in FIG. 1, except that it is described from the perspective of the BS.

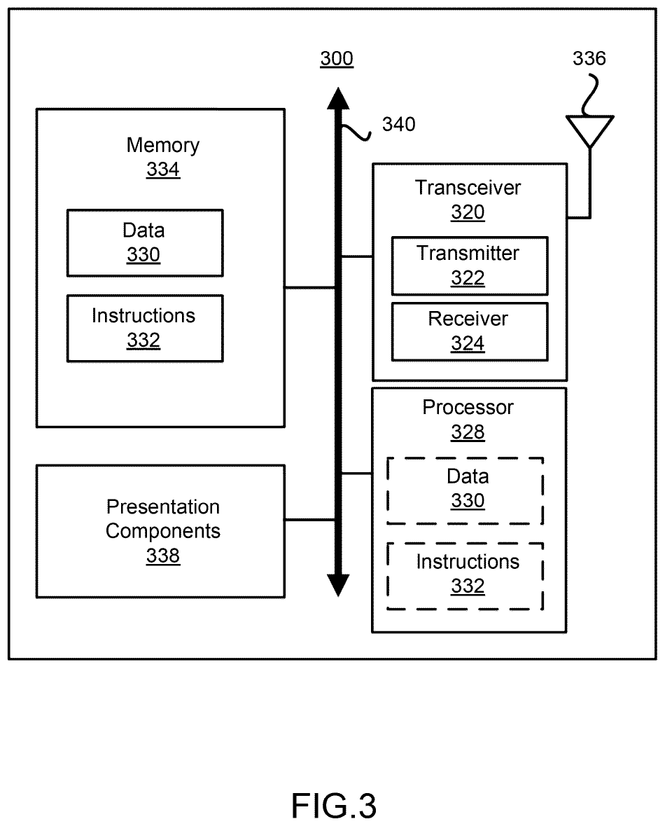

FIG. 3 is a block diagram illustrating a node 300 for wireless communication in accordance with various aspects of the present disclosure. As illustrated in FIG. 3, a node 300 may include a transceiver 320, a processor 328, a memory 334, one or more presentation components 338, and at least one antenna 336. The node 300 may also include a radio frequency (RF) spectrum band module, a BS communications module, a network communications module, and a system communications management module, Input/Output (I/O) ports, I/O components, and a power supply (not illustrated in FIG. 3).

Each of the components may directly or indirectly communicate with each other over one or more buses 340. The node 300 may be a UE or a BS that performs various functions disclosed with reference to FIGS. 1 through 2.

The transceiver 320 has a transmitter 322 (e.g., transmitting/transmission circuitry) and a receiver 324 (e.g., receiving/reception circuitry) and may be configured to transmit and/or receive time and/or frequency resource partitioning information. The transceiver 320 may be configured to transmit in different types of subframes and slots including, but not limited to, usable, non-usable, and flexibly usable subframes and slot formats. The transceiver 320 may be configured to receive data and control channels.

The node 300 may include a variety of computer-readable media. Computer-readable media may be any available media that may be accessed by the node 300 and include volatile (and/or non-volatile) media and removable (and/or non-removable) media.

The computer-readable media may include computer-storage media and communication media. Computer-storage media may include both volatile (and/or non-volatile media), and removable (and/or non-removable) media implemented in any method or technology for storage of information such as computer-readable instructions, data structures, program modules, or data.

Computer-storage media may include RAM, ROM, EPROM, EEPROM, flash memory (or other memory technology), CD-ROM, Digital Versatile Disks (DVD) (or other optical disk storage), magnetic cassettes, magnetic tape, magnetic disk storage (or other magnetic storage devices), etc. Computer-storage media may not include a propagated data signal. Communication media may typically embody computer-readable instructions, data structures, program modules, or other data in a modulated data signal, such as a carrier wave, or other transport mechanisms and include any information delivery media.

The term “modulated data signal” may mean a signal that has one or more of its characteristics set or changed in such a manner as to encode information in the signal. Communication media may include wired media, such as a wired network or direct-wired connection, and wireless media, such as acoustic, RF, infrared, and other wireless media. Combinations of any of the above listed components should also be included within the scope of computer-readable media.

The memory 334 may include computer-storage media in the form of volatile and/or non-volatile memory. The memory 334 may be removable, non-removable, or a combination thereof. Example memory may include solid-state memory, hard drives, optical-disc drives, etc. As illustrated in FIG. 3, the memory 334 may store a computer-readable and/or computer-executable instructions 332 (e.g., software codes) that are configured to, when executed, cause the processor 328 to perform various functions disclosed herein, for example, with reference to FIGS. 1 through 2. Alternatively, the instructions 332 may not be directly executable by the processor 328 but may be configured to cause the node 300 (e.g., when compiled and executed) to perform various functions disclosed herein.

The processor 328 (e.g., having processing circuitry) may include an intelligent hardware device, e.g., a Central Processing Unit (CPU), a microcontroller, an ASIC, etc. The processor 328 may include memory. The processor 328 may process the data 330 and the instructions 332 received from the memory 334, and information transmitted and received via the transceiver 320, the baseband communications module, and/or the network communications module. The processor 328 may also process information to send to the transceiver 320 for transmission via the antenna 336 to the network communications module for transmission to a CN.

One or more presentation components 338 may present data indications to a person or another device. Examples of presentation components 338 may include a display device, a speaker, a printing component, a vibrating component, etc.

In view of the present disclosure, it is obvious that various techniques may be used for implementing the disclosed concepts without departing from the scope of those concepts. Moreover, while the concepts have been disclosed with specific reference to certain implementations, a person of ordinary skill in the art may recognize that changes may be made in form and detail without departing from the scope of those concepts. As such, the disclosed implementations are to be considered in all respects as illustrative and not restrictive. It should also be understood that the present disclosure is not limited to the particular implementations disclosed and many rearrangements, modifications, and substitutions are possible without departing from the scope of the present disclosure.

What is claimed is:

1. A method performed by a User Equipment (UE) for a Simultaneous Transmission with Multi-Panel (STxMP) operation, the method comprising:
receiving, from a Base Station (BS), a configuration for multi-Downlink Control Information (DCI) based STxMP Physical Uplink Shared Channel (PUSCH);
receiving, from the BS, a Sounding Reference Signal (SRS) resource set configuration including a first SRS resource set and a second SRS resource set;
receiving, from the BS, first DCI in a first Control Resource Set (CORESET) associated with a first CORESET pool index;
receiving, from the BS, second DCI in a second CORESET associated with a second CORESET pool index different from the first CORESET pool index;
determining a size of a first field in the first DCI based on a number of first SRS resources configured in the first SRS resource set;
determining a size of a second field in the second DCI based on a number of second SRS resources configured in the second SRS resource set;
transmitting, to the BS, a first PUSCH scheduled by the first DCI based on the first field; and
transmitting, to the BS, a second PUSCH scheduled by the second DCI based on the second field.

2. The method of claim 1, wherein:
the first DCI comprises a DCI format 0_1, and
the second DCI comprises the DCI format 0_1.

3. The method of claim 1, wherein:
the first field in the first DCI comprises a first SRS resource indicator (SRI) field, and
the second field in the second DCI comprises a second SRI field.

4. The method of claim 1, wherein:
both the first SRS resource set and the second SRS resource set are used for non-codebook-based PUSCH transmission,
the first field indicates a first precoder applied to the first PUSCH, and
the second field indicates a second precoder applied to the second PUSCH.

5. The method of claim 1, wherein:
both the first SRS resource set and the second SRS resource set are used for codebook-based PUSCH transmission,
in a case that the size of the first field is not zero, the first field indicates a first beam applied to the first PUSCH, and
in a case that the size of the second field is not zero, the second field indicates a second beam applied to the second PUSCH.

6. The method of claim 1, wherein:
the number of the second SRS resources configured in the second SRS resource set is one, and
the size of the second field in the second DCI is zero.

7. The method of claim 1, further comprising determining a size of the first DCI and a size of the second DCI, wherein:
the size of the first DCI is the same as the size of the second DCI, and
the size of the first field in the first DCI is different from the size of the second field in the second DCI.

8. The method of claim 1, wherein the first PUSCH and the second PUSCH overlap in time domain and frequency domain.

9. A User Equipment (UE) for a Simultaneous Transmission with Multi-Panel (STxMP) operation, the UE comprising:
at least one processor; and
at least one non-transitory computer-readable medium storing one or more computer-executable instructions that, when executed by the at least one processor, cause the UE to:
receive, from a Base Station (BS), a configuration for multi-Downlink Control Information (DCI) based STxMP Physical Uplink Shared Channel (PUSCH);
receive, from the BS, a Sounding Reference Signal (SRS) resource set configuration including a first SRS resource set and a second SRS resource set;
receive, from the BS, first DCI in a first Control Resource Set (CORESET) associated with a first CORESET pool index;
receive, from the BS, second DCI in a second CORESET associated with a second CORESET pool index different from the first CORESET pool index;
determine a size of a first field in the first DCI based on a number of first SRS resources configured in the first SRS resource set;
determine a size of a second field in the second DCI based on a number of second SRS resources configured in the second SRS resource set;
transmit, to the BS, a first PUSCH scheduled by the first DCI based on the first field; and
transmit, to the BS, a second PUSCH scheduled by the second DCI based on the second field.

10. The UE of claim 9, wherein:
the first DCI comprises a DCI format 0_1, and
the second DCI comprises the DCI format 0_1.

11. The UE of claim 9, wherein:
the first field in the first DCI comprises a first SRS resource indicator (SRI) field, and
the second field in the second DCI comprises a second SRI field.

12. The UE of claim 9, wherein:
both the first SRS resource set and the second SRS resource set are used for non-codebook-based PUSCH transmission,
the first field indicates a first precoder applied to the first PUSCH, and
the second field indicates a second precoder applied to the second PUSCH.

13. The UE of claim 9, wherein:
both the first SRS resource set and the second SRS resource set are used for codebook-based PUSCH transmission,
in a case that the size of the first field is not zero, the first field indicates a first beam applied to the first PUSCH, and
in a case that the size of the second field is not zero, the second field indicates a second beam applied to the second PUSCH.

14. The UE of claim 9, wherein:
the number of the second SRS resources configured in the second SRS resource set is one, and
the size of the second field in the second DCI is zero.

15. The UE of claim 9, wherein:
the one or more computer-executable instructions, when executed by the at least one processor, further cause the UE to determine a size of the first DCI and a size of the second DCI,
the size of the first DCI is the same as the size of the second DCI, and
the size of the first field in the first DCI is different from the size of the second field in the second DCI.

16. The UE of claim 9, wherein the first PUSCH and the second PUSCH overlap in time domain and frequency domain.

17. A Base Station (BS) for configuring a Simultaneous Transmission with Multi-Panel (STxMP) operation, the BS comprising:
at least one processor; and
at least one non-transitory computer-readable medium storing one or more computer-executable instructions that, when executed by the at least one processor, cause the BS to:
transmit, to a User Equipment (UE), a configuration for multi-Downlink Control Information (DCI) based STxMP Physical Uplink Shared Channel (PUSCH);
transmit, to the UE, a Sounding Reference Signal (SRS) resource set configuration including a first SRS resource set and a second SRS resource set;
transmit, to the UE, a first DCI in a first Control Resource Set (CORESET) associated with a first CORESET pool index;
transmit, to the UE, a second DCI in a second CORESET associated with a second CORESET pool index different from the first CORESET pool index;
receive, from the UE, a first PUSCH scheduled by the first DCI; and
receive, from the UE, a second PUSCH scheduled by the second DCI, wherein:
the SRS resource set configuration enables the UE to determine a size of a first field in the first DCI based on a number of first SRS resources configured in the first SRS resource set,
the first DCI enables the UE to transmit the first PUSCH based on the first field,
the SRS resource set configuration enables the UE to determine a size of a second field in the second DCI based on a number of second SRS resources configured in the second SRS resource set, and
the second DCI enables the UE to transmit the second PUSCH based on the second field.

18. The BS of claim 17, wherein:
the first DCI comprises a DCI format 0_1,
the second DCI comprises the DCI format 0_1,
the first field in the first DCI comprises a first SRS resource indicator (SRI) field, and
the second field in the second DCI comprises a second SRI field.

19. The BS of claim 17, wherein:
the number of the second SRS resources configured in the second SRS resource set is one, and
the size of the second field in the second DCI is zero.

20. The BS of claim 17, wherein:
the size of the first DCI is the same as the size of the second DCI, and
the size of the first field in the first DCI is different from the size of the second field in the second DCI.
